(19) United States
(12) Patent Application Publication
(10) Pub. No.: US 2012/0036263 A1
(43) Pub. Date: Feb. 9, 2012

(54) System and Method for Monitoring and Controlling Access to Web Content

(75) Inventors: John William Madden, Barrie (CA); Pavel Tchourliaev, Richmond Hill (CA); Xin Dong, Toronto (CA)

(73) Assignee: Open Subnet Inc., Markham (CA)

(21) Appl. No.: 13/277,776

(22) Filed: Oct. 20, 2011

Related U.S. Application Data
(63) Continuation-in-part of application No. 13/112,861, filed on May 20, 2011.
(60) Provisional application No. 61/347,162, filed on May 21, 2010.

(51) Int. Cl. G06F 15/173

(52) U.S. Cl. 709/225

(57) ABSTRACT

A system and a method are provided for controlling access to web pages. It includes receiving an input to access a web page, and then determining if the Web page is on a work list or a recreation list. The work list includes one or more web pages related to work and the recreation list includes one or more web pages related to recreation. If the web page is not on either list, then a request is issued for a categorization of the web page. Upon receiving the categorization, the web page is stored in the work list or the recreation list, and access is provided to the web page.

### CROSS-REFERENCE TO RELATED APPLICATIONS

The present application is a continuation-in-part of U.S. patent application Ser. No. 13/112,861 filed May 20, 2011, which claims priority from U.S. patent application No. 61/347,162 filed May 21, 2010, all of which are hereby incorporated by reference in their entirety.

### TECHNICAL FIELD

The following relates generally to monitoring and controlling access to web content.

### BACKGROUND

The world-wide-web (WWW) and other information and data available via the Internet is known to contain both useful and appropriate content and non-useful and/or inappropriate content. For example, some web pages may contain material that is deemed to be inappropriate for minors, such as pornography or graphic violence, and other web pages may be deemed frivolous and thus inappropriate when accessed in the workplace environment during working hours.

Various mechanisms have been employed in an attempt to control access to the varied content available through the WWW. For example, Internet sites or particular web pages can be blacklisted, i.e. “forbidden” and using an appropriate software tool, access to such web pages can be blocked. One problem with blacklisting is that new web pages are being added continuously or changing locations or domains and thus keeping an up-to-date blacklist is typically quite onerous. Accordingly, despite the effort involved in blocking some web pages, users can still find newer content that is equally inappropriate but as yet not blacklisted.

Web pages can also be white listed, i.e. deemed “acceptable” such that only those sites on the white list can be accessed. One problem with white listing is that it can be difficult to determine what is appropriate such that once it is added to the list, its appropriateness is implied. As such, white lists tend to evolve slowly thus blocking content that should be acceptable but is not yet on the white list thus creating a frustrating experience for the user.

### BRIEF DESCRIPTION OF THE DRAWINGS

Embodiments will now be described by way of example only with reference to the appended drawings wherein:

FIG. 1 is a block diagram illustrating a system for generating and controlling subnet lists.

FIG. 2 is a block diagram illustrating an example configuration for the system of FIG. 1.

FIG. 3 is block diagram illustrating an example configuration for the open subnet (OSN) of FIG. 2.

FIG. 4 is a chart illustrating an example mapping between user type and voting contributions.

FIG. 5 is a block diagram illustrating an example voting procedure implemented by the voting system of FIG. 1 for registered users.

FIG. 6 is a block diagram illustrating an example voting procedure implemented by the voting system of FIG. 1 for guest users.

FIG. 7 is a flow chart illustrating an example voting calculation.

FIG. 8 is a block diagram illustrating an example subnet search and voting process from the search results.

FIG. 9 is a block diagram illustrating an example subnet review page and voting process from the review page.

FIG. 10 is a block diagram illustrating an example configuration for the third party intermediary of FIG. 2.

FIG. 11 is a flow chart illustrating a hierarchy for searching in various example subnets.

FIG. 12 is a flow chart illustrating a user profile hierarchy under a license.

FIG. 13 is a block diagram illustrating an example configuration for a client service to communicate with an intermediary via the sync server of FIG. 2.

FIG. 14 is a block diagram illustrating an example configuration for the sync server of FIG. 2.

FIG. 15 is a flow diagram illustrating example computer executable instructions executed by the sync server for updating a copy of a white list.

FIG. 16 is a flow diagram illustrating example computer executable instructions executed by the sync server for blocking or approving a web page request and determining the validity of a licence to access a subnet.

FIG. 17 is a screen shot of an example graphical user interface (GUI) for the search engine of FIG. 3.

FIG. 18 is a block diagram illustrating an example a white list database or copy of a white list database, including recreational and work website lists, and an access log.

FIG. 19 is a flow diagram illustrating example computer executable instructions for categorizing a website as related to work or recreation and displaying the same.

FIG. 20 is a flow diagram illustrating example computer executable instructions for determining if a web page is blocked, uncategorized or categorized according to an operation in FIG. 19.

FIG. 21 is a block diagram illustrating example rules in a rules database related to recreation websites.

FIG. 22 is a screenshot of an example GUI for selecting a category of a website.

FIG. 23 is a screenshot of an example GUI displaying a website and an indicator of the selected category.

FIG. 24 is a block diagram illustrating example functions of an owner or moderator.

FIG. 25 is a block diagram illustrating example functions of a member or a guest.

FIG. 26 is a screenshot of an example GUI for displaying websites in a work website list.

FIG. 27 is a screenshot of an example GUI for displaying websites in a recreation website list.

FIG. 28a is a screenshot of an example GUI for displaying the access log to websites.

FIG. 28b is a screenshot of an example GUI for displaying options to adjust which websites in the access log are flagged.

FIG. 29 is a flow diagram illustrating example computer executable instructions for determining whether to automatically provide access to a second web page after providing access to a parent web page.

FIG. 30a is a flow diagram illustrating example computer executable instructions for recording the amount of time a user has accessed a first web page.

FIG. 30b is a flow diagram illustrating example computer executable instructions for estimating the amount of time the user has accessed the first web page based on the information recorded from FIG. 30a.

### DETAILED DESCRIPTION OF THE DRAWINGS

It has been found that providing a system and a method for generating subnets using a voting strategy allows for a collection of approved domains or web sites to grow more quickly. A voting strategy also allows for users of different rankings to have greater influence on the approved or rejected web content. The subnets can also be used to effectively control access to web content based on a user's profile, and their license to one or more subnets. In this way, the control of access to web content is more easily distributed and managed amongst many users. Furthermore, the combination of the voting strategy and the subnets allows the control of access to the web content to evolve over time based on the accumulation of users' opinions.

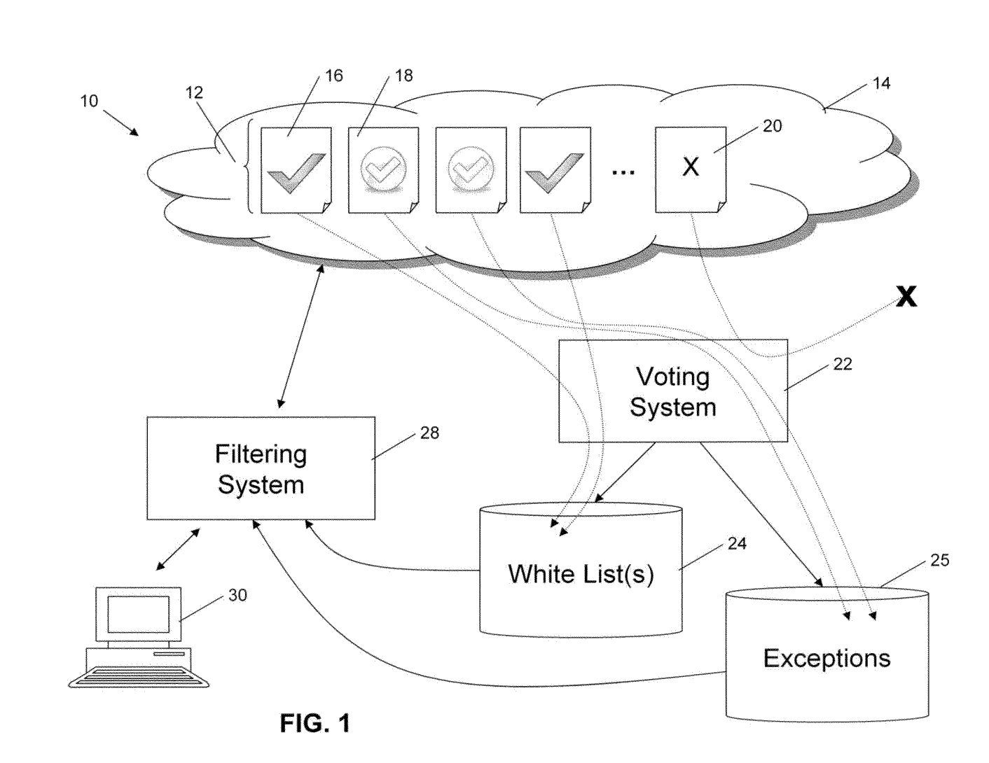

Turning now to FIG. 1, a system 10 is shown that enables content 12 available on the Internet 14 to be evaluated using a voting system 22 to generate subnets comprising one or more white lists 24 specifying white listed content 12, and to generate user-specific exceptions 25 defining content 12 that may be inside or outside a white list 24 but is still deemed unacceptable or acceptable to that particular user. The white lists 24 and exceptions 25 provide a way to determine the acceptability and/or appropriateness of particular content 12. By using the voting system 22, the white lists 24 and exceptions 25 can be built collaboratively and can provide a level of trust or credibility to content control. The system 10 also enables such white lists 24 and exceptions 25 to be used by a filtering system 28 to control a user's access to the Internet 14, e.g. via a personal computer (PC) 30, as shown, or other Internet-enabled device (not shown). Other examples of internet-enabled devices that can be used include mobile devices, tablets, laptops, personal digital assistants, cell phones and smart phones.

In the example shown in FIG. 1, the content 12 comprises one or more white-listed content items 16 (e.g. white listed web sites or pages), which are accessible to the PC 30 via the filtering system 28 on a subnet specific basis. The content 12 may also comprise one or more exception items 18, which are either deemed accessible or inaccessible to the PC 30 via the filtering system 28 on a user-specific basis. The content 12 may also comprise one or more blocked items 20, which are not part of a white list 24 or acceptable via an exception 25. It can be appreciated that the distinction between a blocked item 20 and an exception that blocks an item regardless of its status with respect to the white lists 24 is only for illustrative purposes. For example, an item may be deemed a blocked item 20 with respect only to a particular white list 24 while being deemed acceptable in other white lists 24 and thus to those that have access to the subnets associated with such other white lists 24.

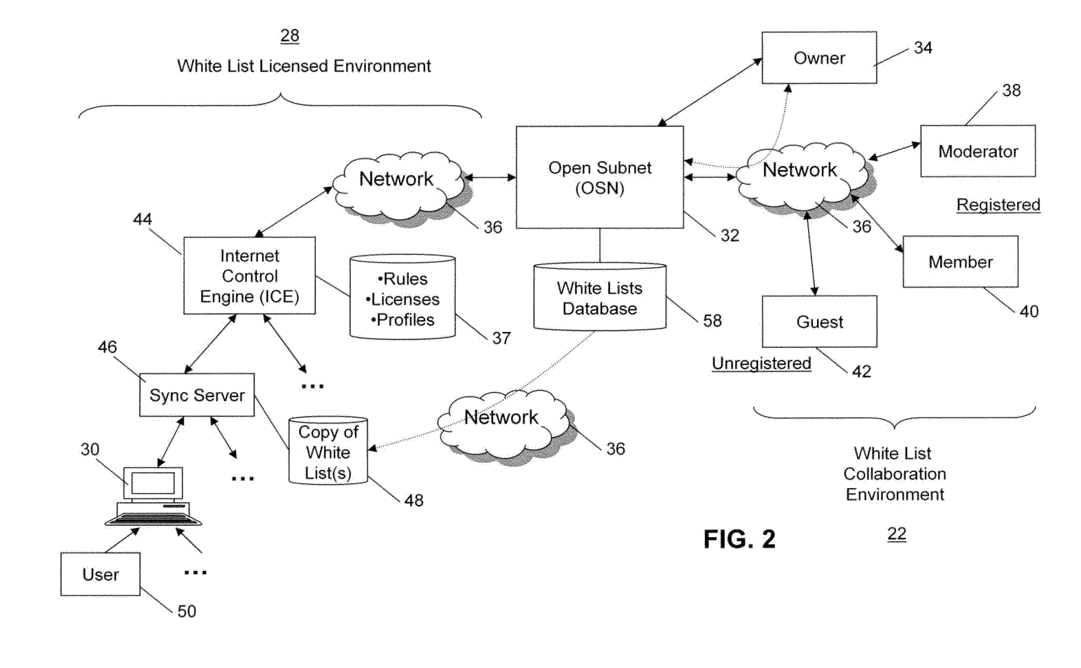

Turning now to FIG. 2, an example configuration for providing the voting system 22 and filtering system 28 is shown. In this configuration, a server, referred to herein as the Open Subnet (OSN) 32 is accessible via a network 36 (such as the Internet 14) by various entities in order to enable a white lists database 58 to be generated in a collaborative manner using the voting system 22. In the example shown, an owner 34 may access the OSN 32 either directly or via the network 36 and can control what content 12 is added to a particular white list 24. As will be explained in greater detail below, the owner 34 can be given a veto power or have their voting contributions heavily weighted when compared to other entities in order to give the owner 34 increased control over the voting procedure. For example, the owner 34 could represent a school administrator that controls the generation and evolution of a subnet for a particular school or school board and thus has the ability to ensure that certain content 12 is blocked or allowed.

As noted, the system 10 enables the white lists 24 to be created and to evolve in a collaborative manner in order to provide a level or trust and/or credibility to the subnet that is defined by the white lists 24. In order to encourage collaboration, the OSN 32 can allow both registered and unregistered users to contribute to the voting system 22. In this example, registered users include one or more moderators 38 and one or more members 40. It can be appreciated that more or fewer levels of granularity can be provided to distinguish between members in the hierarchy. For example, various member tiers can be used or master moderators chosen from groups of moderators, etc. This example illustrates unregistered users as being guests 42. This allows observers or other interested parties to contribute to the evolution of a white list 24 either to gain membership within the voting system 22, or to strengthen a white list's relevance, similar to a wiki type system. As will be explained in greater detail below, the voting system 22 enables various user roles to be defined with corresponding maximum contributions to favour those that are responsible for or more likely to utilize the white list 24.

The collaborative generation of white lists 24 enables the OSN 32 to provide the white lists 24 to the filtering system 28 in order to control access to the Internet 14 according to what is defined in the white lists 24 and any user-specific exceptions 25 that have been applied. The white lists 24 can therefore be provided via licenses such that one group or entity can be responsible for generating and evolving the white list 24 whilst others can benefit from the collaborative efforts inherent therein. The OSN 32 can thus provide an interface between the generation and maintenance of the white lists 24 and their use in a licensed environment.

The OSN 32 in this example is connectable to a third party intermediary 44 via the network 36. The intermediary 44 can be server, engine or other device or entity that is capable of communicating over the network 36. The intermediary 44 maintains an internet control database 37 which may include rules, licenses, profiles, and other data and information that enables a user 50 to use the filtering system 28 according to one or more white lists 24. The intermediary 44 may also be referred to as an Internet Control Engine (ICE). It can be appreciated that the OSN 32 and intermediary 44 are shown as separate entities for illustrative purposes only and could instead be the same entity providing both collaboration and licensed use functionality. By separating the OSN 32 from the intermediary 44, other entities can access the OSN 32 in a manner similar to the intermediary 44 such that different organizations can license white lists 24 in different geographic or demographic areas or in different industries. For example, the intermediary 44 can be used to control Internet traffic in a school environment and a separate Internet security company can also connect to the OSN 32 to license white lists for providing consumer-based Internet security software and services. As such, the configuration shown in FIG. 2 can be modified or take different forms depending on the nature of the application and relationships between the OSN 32 and other entities.

To enable many users 50 in multiple locations to access the intermediary 44, one or more sync servers 46 can be used. The sync servers 46 have access to a white list database 48, which includes copies of the white listed content 12 that enables the sync server 46 to perform a comparison of a request/query from the PC 30 to a licensed white list 24 in order to block or allow content 12 to the user 50. The white list database 48 should be under the control of the OSN 32 such that the white list contents are not divulged.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media. may include volatile and non-volatile, removable and non-removable media implemented in any method or technology for storage of information, such as computer readable instructions, data structures, program modules, or other data, except transitory signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the OSN 32, database 58, intermediary 44, sync server 46, database 48, PC 30, etc., or accessible or connectable thereto. Any application or module herein described may be implemented using computer readable/executable instructions that may be stored or otherwise held by such computer readable media.

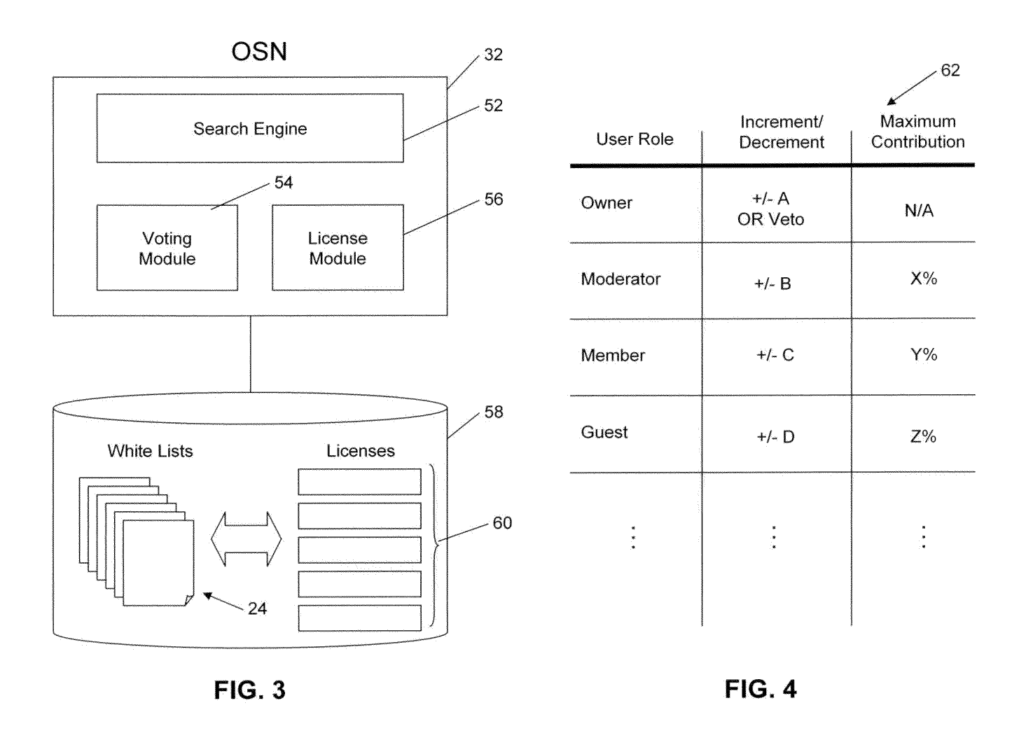

To enable collaboration, the OSN 32 provides web searching capabilities as a way in which to allow registered and non-registered users to vote on particular content 12. FIG. 3 shows an example configuration for the OSN 32. The OSN 32 comprises a search engine 52 or other web module that provides searching capabilities. The OSN 32 also comprises a voting module 54 to enable the voting system 22 to be integrated into or with the search engine 52. The OSN 32 also comprises a license module 56 to track licences that have been granted to intermediaries 44. The white lists database 58 is also shown in FIG. 3 and comprises a series of white lists 24 that have been generated and are evolving in the collaborative environment. The database 58 also comprises details of various licenses 60 and how they map to the various white lists 24. For example, one or more licences 60 may permit access to one or more than one white list 24 and may define the number of entities that may access a particular white list 24 under that license. In this way, the OSN 32 can control who and what has access to the valuable information contained in each white list 24.

To determine whether or not particular content 12 is added to a white list 24, and to evolve the contents of the white list 24, e.g. to move domains through from a “pending” to “approved” status, a voting scheme can be implemented in the voting system 22, an example of which is shown in FIG. 4. In the example voting scheme shown in FIG. 4, each user role (owner 34, moderator 38, member 40, guest 42 in this example) has associated therewith, an increment/decrement value, and a maximum contribution. The increment/decrement value indicates the number of points that are contributed to an overall score for each vote by that type of user. The maximum contribution value can be used to set, for example, a maximum percentage of the overall score that can come from that type of user. For example, to limit results being skewed by guests 42, a maximum of, for example, 30% can be imposed. It will be appreciated that the maximum contribution may or may not be a percentage of the total score. In the example scheme of FIG. 4, the owner 34 is not given a maximum contribution in order to allow the owner 34 to have dominating control over the score and/or veto power. The owner can thus being given a highest increment/decrement value (+/−A) or a discrete veto capability. The moderators 38, members 40, and guests 42 are then given increment/decrement values (B, C, D) that should diminish in value such that the guest 42 has the lowest contribution to the scoring. Similarly, declining maximum contributions (X, Y, Z) can be given to these entities in the order of the hierarchy.

To illustrate how the example scheme in FIG. 4 can be implemented, the following scenario assumes that a score of greater than 99 approves the content 12, a score of less than −99 blocks the content 12, and a score between −99 and 99 indicates a “pending” status. The pending status allows the content 12 to be evaluated over time and across many user-types to evolve the score through collaboration. In this way, the content 12 does not need to be scored and firmly evaluated right away but instead can be proposed and then voted on over time. This also allows the acceptability of content 12 to fluctuate over time such that even though the content 12 is approved now, if negative voting occurs in the future (e.g. if the content's appropriateness changes later), the content 12 can move back into the pending status or blocked status. To utilize the ranges above, one can assume that A=100, B=20, C=10, and D=1. Also, to control contributions from the different groups, X=80%, Y=60%, and Z=20%. In this way, moderators 38 can have a much greater influence over the score than guests 42 since, even if many guests 42 vote in a particular way, in order for the content 12 to be approved some contribution must come from other user types (assuming a 50% pass threshold).

Since A=100 in this example, if the owner 34 votes for a particular content item 12, it would be approved right away. Conversely, regardless of the score owing to the other user types (since the contributions can be capped), by voting against a particular content item 12, the −100 would ensure that the score remains in the pending or blocked categories. The owner 34 can promote other users to member 40 or moderator 38 status in order to give them more voting power. In this way, although the owner 34 has a powerful contribution to the voting score, if important users such as moderators 38 vote against a domain that was approved by the owner 34 or conversely vote for a domain that was denied by the owner 34, the overall score can overcome the owner's contribution. This allows the collaborative environment to offer a democratic voting scheme in order to ensure that domains are added to a white list 24 or blocked based on the collaborative efforts of various users rather than solely based on the owner's vote.

The search engine 52 enables users, e.g. members 40 to find content 12 within a particular subnet defined by a white list 24 and any content 12 that is returned in a search query can be voted on. The content 12 that is returned has already been added to a white list 24 but can be further voted on to change its status, e.g. to change from “pending” to “approved” based on further collaborative contributions. In another example: the status of a domain can change over time from an “approved” status to a “pending” status or to a “denied” status, should the voting users (e.g. members 40, moderator 38, owner 34, guest 42) decide that domain is not appropriate for the subnet. This may be the case where, in an example scenario, a certain domain originally perceived to be appropriate, is later found to be unreliable or a distraction to users. Therefore, the approved status of the certain domain may diminish.

It is noted that the search engine 52 works differently based on whether it is in the collaborative environment 22 or the usage environment 28. In the usage environment 28, a user 50 can only see search results that are approved. Therefore, the user 50 does not see or is not able to view the pending or denied domains.

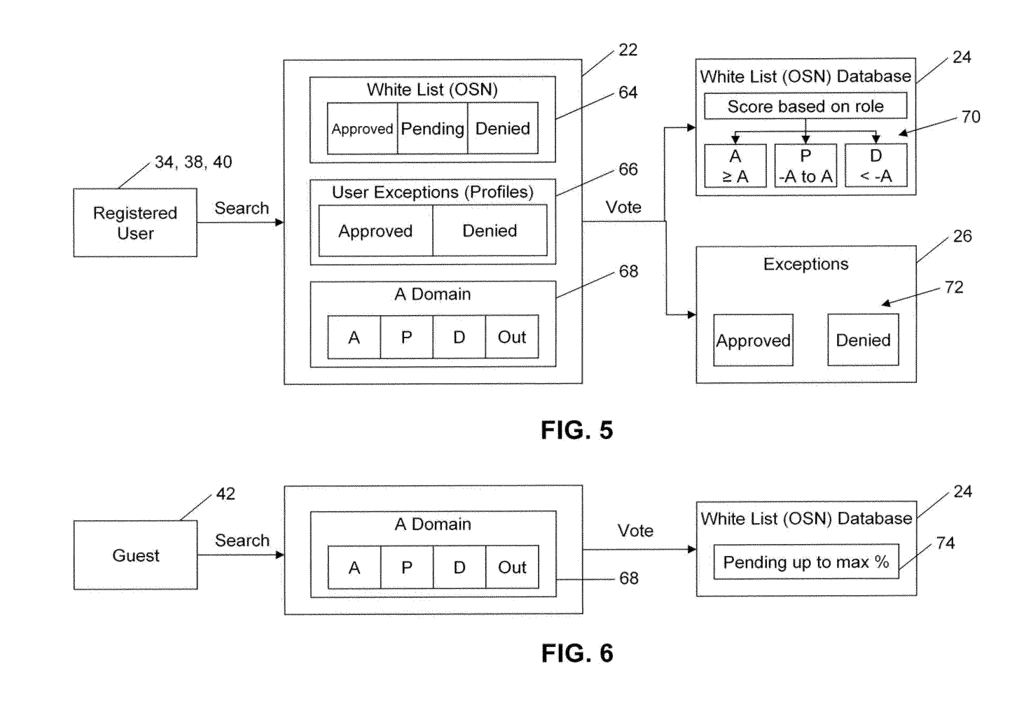

FIG. 5 illustrates a flow chart for an example search query made by a registered user 34, 38, 40 to show how the voting system 22 affects a content 12 within a white list 24. The voting system 22 enables white listed results 64, user exception results 66, and other domain results 68 to be returned. For white list results 64, the status can be approved, denied, or pending. For user exception results 66 the content 12 is either approved or denied. Other domains and their associated results 68 may be approved, pending, denied, or out of the subnet. In this way, if a domain is not within a particular subnet defined by a white list 24, it is marked “out of subnet” to track which domains have not been voted on but have been added to the system 10 and are not yet pending. The results 64, 66, 68 that are provided to the user performing the search enable the user to vote, which then can update the score to an existing white list 24 at 70, or modify the exceptions 26 at 72. It can be appreciated that the other domain results 68 can be added to a white list 24 through this process, or can be added to the exceptions 26 by applying a vote. The search results 64, 66, 68 enables changes to be made to the status of content 12, which is then reflected in changes to the white list database 24 and/or exceptions database 25.

FIG. 6 illustrates a search that may be performed by a guest 42. The guest 42 is able to perform a search in order to return other domain results 68 and by voting on the content in those results. The white list 24 can be updated at 74, e.g. to add the “pending” status to a particular domain to be added to the white list 24. In this example, “A domain” represents any content 12 that, if added to the system 10, would be added to the “out” status. Based on voting, the content 12 in the “out” status may then enter the pending, approved, or denied statuses. This allows the voting system 22 to be applied to any public domain on any subnet.

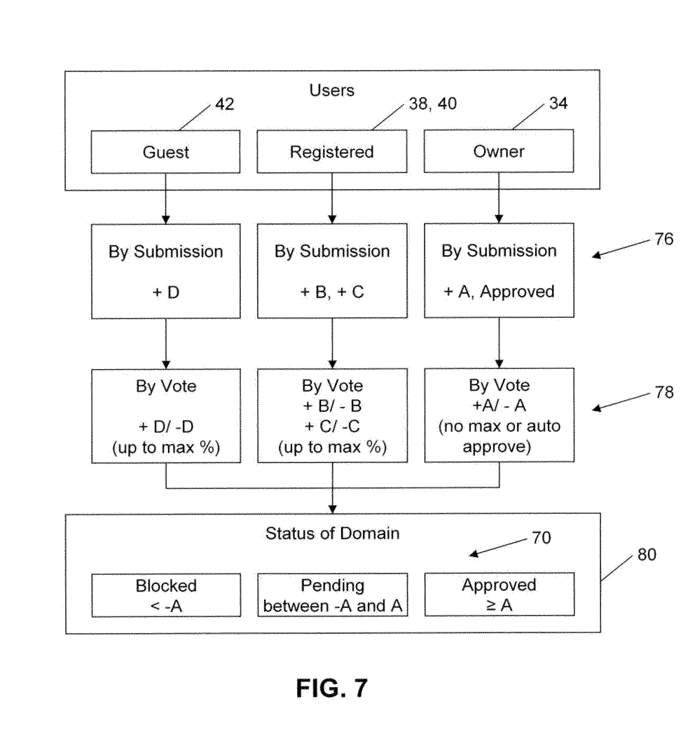

The voting scheme is further illustrated in FIG. 7. In FIG. 7 the guests 42, registered users 38, 40, and owner 34 user types are shown at the top of the flow chart. By submitting content 12 to be added to a white list 24 at 76, the respective increment value is added. If the user is instead voting for content 12 that has already been submitted at 78, the corresponding increment or decrement value is added to or subtracted from the current score (assuming the maximum contribution has not been exceeded) and the status of the domain (content 12) is updated at 80.

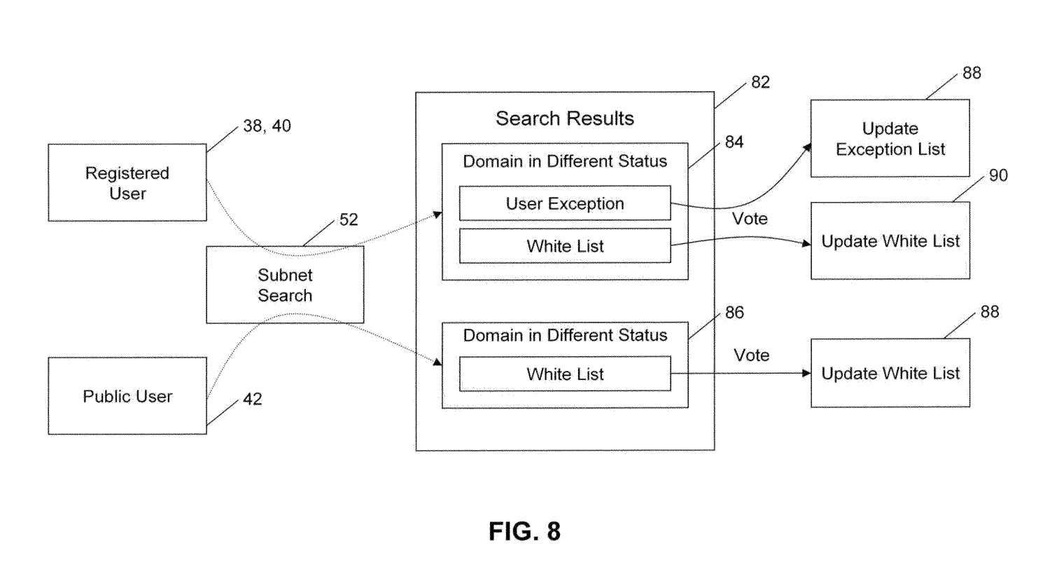

FIG. 8 shows the flow of data during a search within a white list 24. The registered users 38, 40 can perform a subnet search at 52 and the search results 82 returns a domain in a different status (e.g. approved, pending, denied, out). This allows the registered users 38, 40 to add a domain to their user, profile 26 as an exception or to vote on a domain to add it to a white list 24. The exception list may then be updated at 88 and/or the white list database 24 updated at 90. Public users (e.g. guests 42) can also vote on search results 86 that enable them to contribute to the score of a domain for a particular white list 24. The white list 24 may then also be updated based on contributions from the public user 42 at 90.

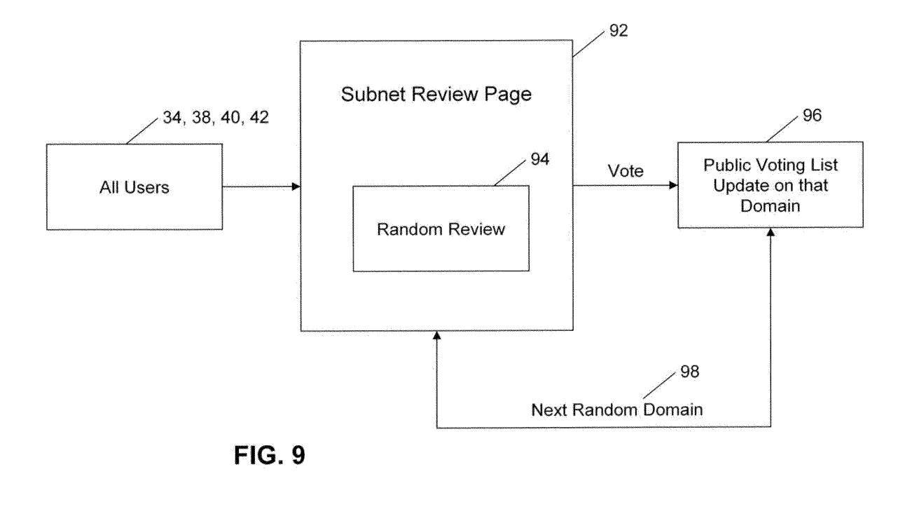

FIG. 9 illustrates a subnet review page 92 that can be used to perform a random review 94. Any user can vote on a random review 94 in order to update the voting list for that domain. The next random domain can then be reviewed at 98. The random review 94 enables websites to be submitted for review to further enhance a white list 24.

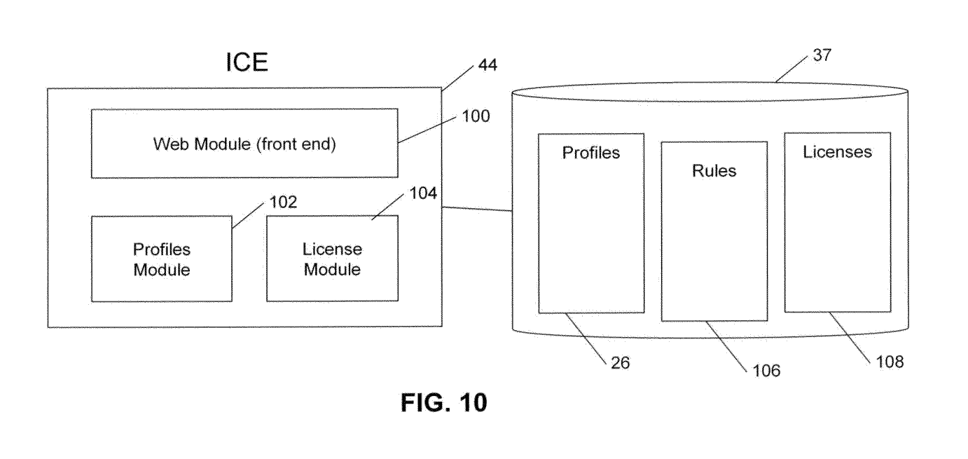

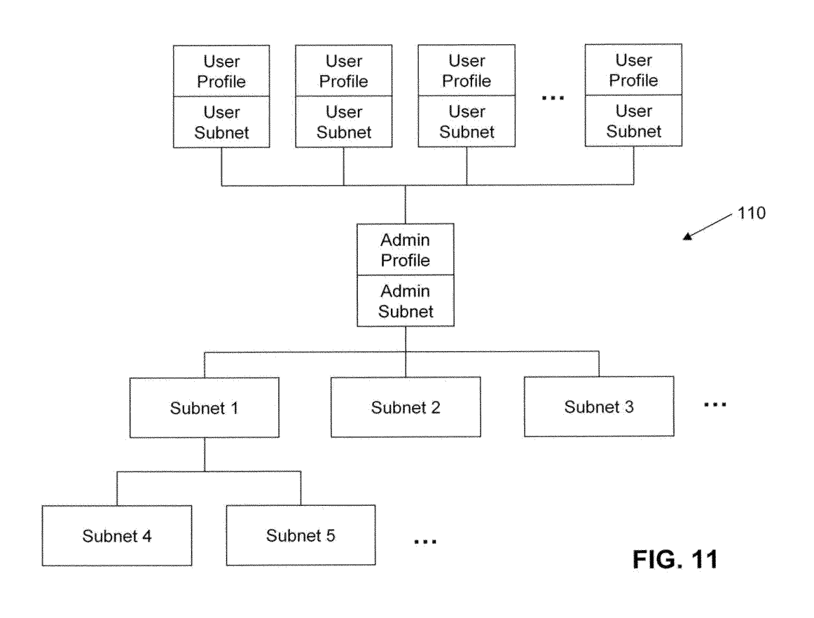

An example configuration for the intermediary 44 is shown in FIG. 10. The intermediary 44 has a web module 100 that provides a front end for users and administrators to configure users profiles 26 via a profiles module 102 and to purchase, renew or modify licenses 108 via a license module 104. The profiles 26 enable different users 50 to have exceptions 25 defined for their profile and define other rules such as how many and which white lists 24 a particular user 50 can access. The intermediary 44 there controls use of a white list 24 according to licences granted on a per-user basis. The rules 106 may represent any other feature that can be relied on to control use of the white lists 24 for various users 50. FIG. 11 illustrates a hierarchy that enables a user to search within various subnets. A user profile 26 can define which licences 108 apply to them. An admin profile and admin subnet can then control the licenses that govern the user's access to the various subnets under those licenses. The admin profile and admin subnet can be used to control the addition or removal of users 50 to the admin profile which in turn enables those users 50 to apply their profiles to the subnets allowed under the licenses granted to the admin.

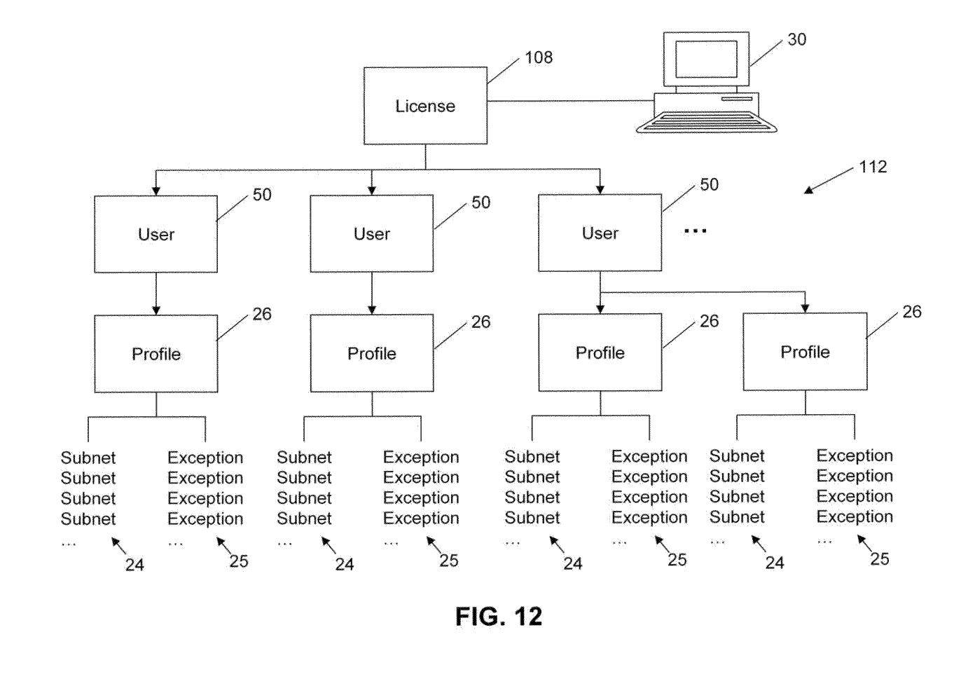

FIG. 12 illustrates an example license structure. In this example, a PC 30 has associated therewith, a license 108. The license 108 is associated with a number of users 50, each of which has a profile 26. The profiles define which subnets or white lists 24 are available to that user and the exceptions 25 that apply. A user 50 can have more than one profile 26 as shown. It can therefore be seen that the licenses 108 controlled through the intermediary 44 enable the PC 30 to control the content 12 that is delivered to various users 50 according to what is defined as being acceptable for that user.

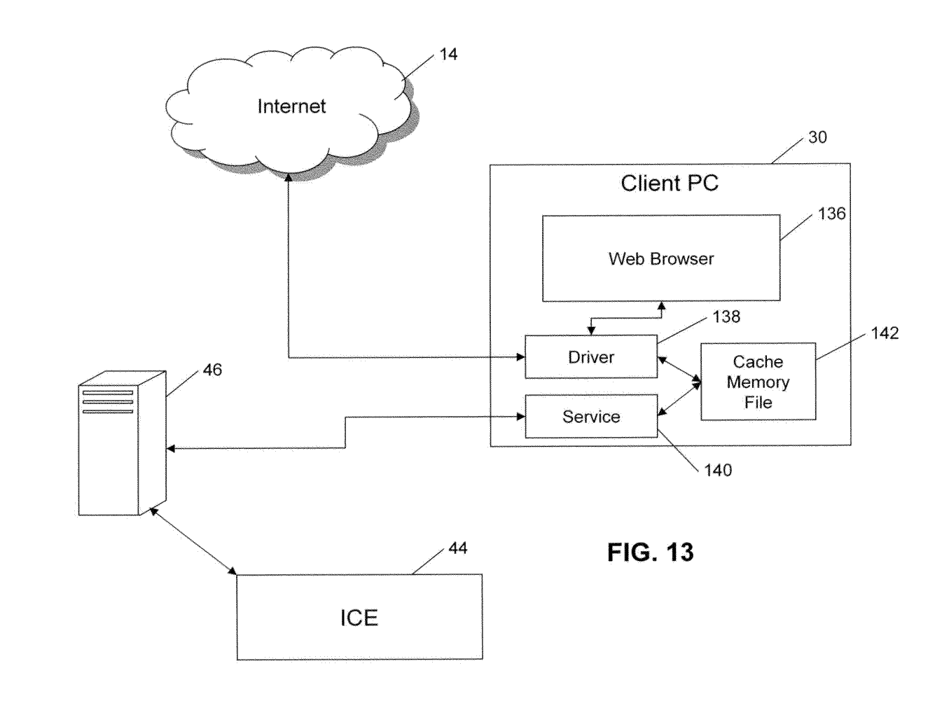

FIG. 13 illustrates an example configuration for a client service 140 to communicate with the intermediary 44 via the sync server 46. The PC 30 includes software for a web browser 136, a service 138, memory 142, and the client service 140. The web browser 136 (e.g. Internet Explorer™, Firefox™, etc.) is run by a service 138 that is connected to the Internet 14. The service 138 is also in communication with the memory 142, whereby the memory 142 stores information about the user's white lists, licenses to white lists and exceptions 25, as described above. Based on such information, the. service 138 determines which websites can or cannot be accessed and displayed on the web browser 136. The client service 140 is also in communication with the memory 142 to determine the status of the white list or subnet licensing information (e.g. the time the information on memory 142 was last updated). The client service 140 is also in communication with the sync server 46, and the sync server 46 is in communication with the intermediary 44.

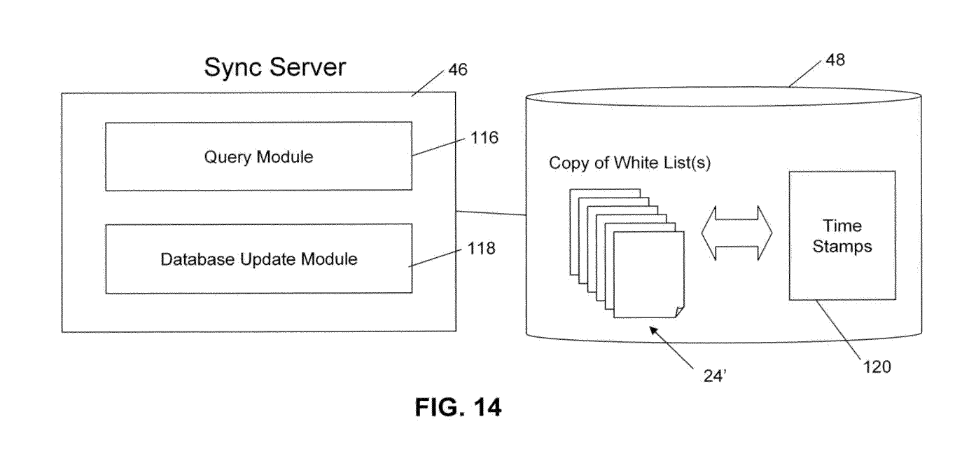

FIG. 14 illustrates an example configuration for the sync server 46. The sync server 46 comprises a query module 116 to enable queries to be performed to determine if content 12 requested by a user 50 should be allowed or blocked. The sync server 46 also has an update module 118 for determining if its local copy of the white lists 24 should be updated. To facilitate such updates, time stamps 120 that correspond to the last time each white list 24 was updated can be stored in the database 48.

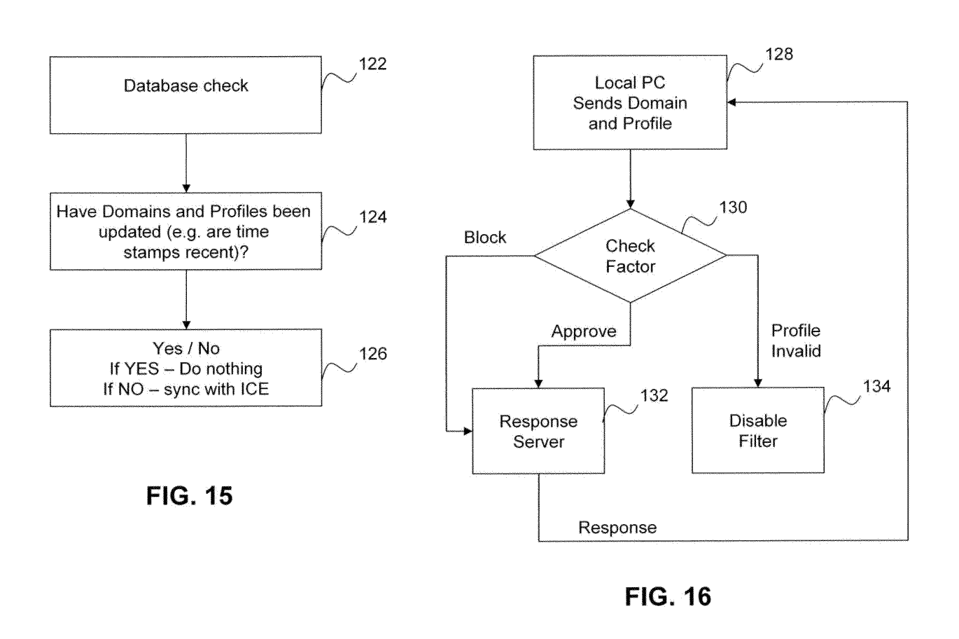

FIG. 15 illustrates example computer executable instructions that allows the sync server 46 to update a copy of a white list. At block 122, the sync server 46 checks the status of the database 28 holding the copy of the white lists. For example, the sync server 46 determines whether or not the database 48 has been updated recently. The sync server 46 compares the time stamp 120 of the most recent copy of the white list on the database 48 with the time of the most recent change to the white list 58, which is managed by the OSN 32 (block 124). If the time of the most recent change to the white list 58 is more current or recent than the time on the most recent time stamp 120, which mark when the copy of the white list was last updated in the database 48, then the sync server 46 will initiate a synchronization between the local white list in database 48 and the white lists in database 58 (block 126). In particular, the sync server 46 will obtain the most updated changes to the domains and profiles of the user from the intermediary 44. If, however, the time stamp of the last update to the database 48 is more recent than the last change to the database 58, then no action is taken. The updates that are local to the sync server 46 are then propagated or transmitted to the connected PCs 30 through the client service 140.

It can be appreciated that the method described with respect to FIG. 15 also applies to updating the white lists or subnet licenses on the memory 142 of the PC 30. There may be time tags associates with the updates to the white lists or subnet licenses on the memory 142. The client server 140, via the sync server 46, can synchronize the changes on the database 48 with the white lists or subnet licenses on the memory 142.

Turning to FIG. 16, a flow diagram is provided to illustrate example computer executable instructions executed by the sync server 46 for blocking or approving a web page request and determining the validity of a licence to access a subnet. In particular, a user on a PC 30 may request to access a certain internet web site, e.g. domain, and the request from the PC 30 may be sent to the sync server 46 for processing. At block 128, the local PC 30 sends the request for the domain and its profile information to the sync server 46. At block 130, the sync server 46 receives the domain and the user's profile information, and then determines whether or not the profile is approved or invalid or blocked (e.g. denied). If the profile is invalid, the filter is disabled (block 134). If the profile is approved, then the sync server 46 provides a response to the PC 30, regarding whether or not the request is allowed to be accessed (block 132). If the profile is blocked (e.g. denied), then the sync server 46 also provides a response to the PC 30. For example, if blocked, the sync server 46 provides a response that based on the profile, access is denied.

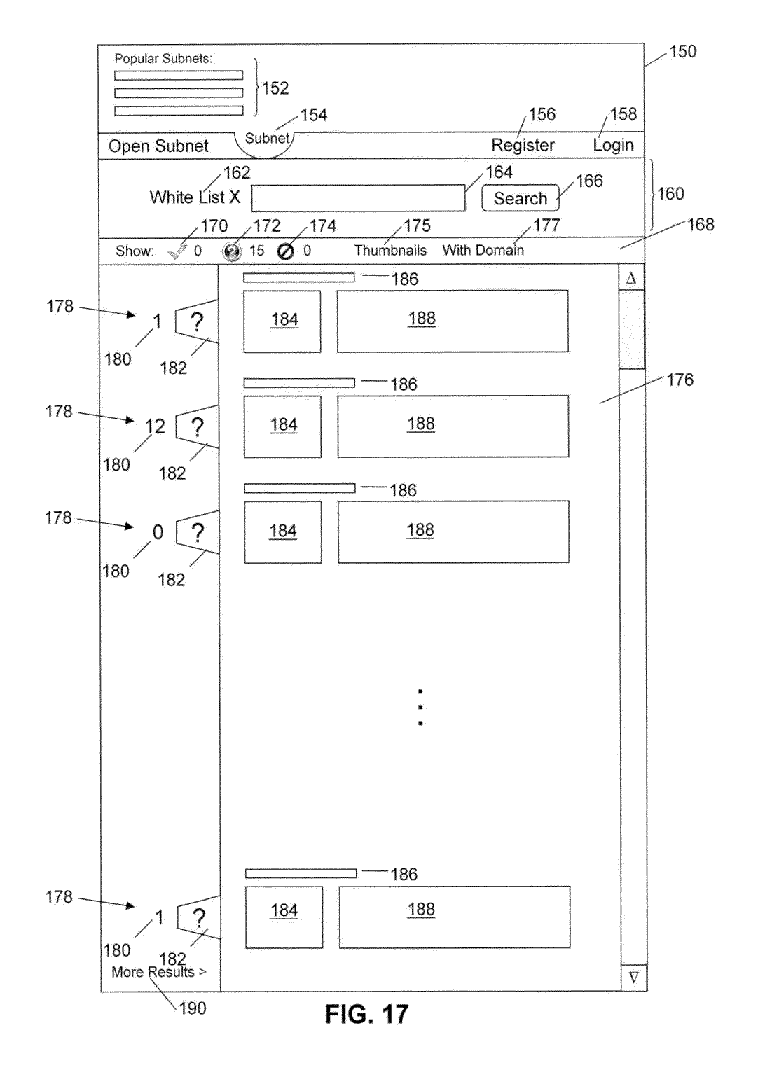

Turning to FIG. 17, a screen shot 150 of an example. GUI for the search engine 52 is provided. In the upper portion of the screen 150, there may be a list of popular subnets 152. In one embodiment the list 152 shows subnets that have been licensed to the user. A user can select or click on different subnets from the list 152 to search for information within the subnet. A particular subnet 154 may be selected and its related activities and information is shown in the body of the screen 150. The screen 150 also includes a register 156 button, e.g. for registering as a new user, and a login button 158, e.g. for logging in as an existing user. A search bar 160 allows a user to input text into the search field 164 to search for websites within the white lists of the selected subnet 154. This is indicated by the marking “White List” 162. Selecting or clicking on the search button 166 initiates the search of the white lists based on the provided search parameters. A results summary bar 168 allows the user to quickly view the number of approved domains, the number of pending domains, and the number of rejected domains; these are shown by the icons 170, 172, and 174 respectively. Buttons or interfaces 175 and 177 allow the user to control whether thumbnails of the websites and the full domain address are shown, respectively. One or more of the search results 178, e.g. websites or domains, are listed in the main body 176 of the screen 150. Each search result 178 shows the number of votes, or the voting score 180 and a status symbol 182 to indicating whether the domain is approved, pending or rejected. In this case, all the domains shown are pending, as indicated by the question mark. The search result 178 also includes the name of the website or domain 186, a thumbnail 184 illustrating a portion of the website or domain, and a description 188 of the website or domain. At the bottom of the screen 150, there may also be another interface or button 190 that the user can click or activate to view more results.

It can be appreciated that the modular configuration of the subnets and the characteristics of the voting structure that allow for a subnet to quickly evolve allows for the creation and maintenance of many high quality subnets. As more users or voters provide their opinion on whether to approve or deny a website or domain, typically, the quality and relevance of the domains within a website increases. In an organization example, such as a school, one school may create and maintain a number of subnets related to academic subjects (e.g. a “history” subnet, a “math” subnet, a “science” subnet, etc.), and the subnets may be used to control students' access to web content. If the school's subnet is perceived to be of high quality, another school may desire to license the school's subnets, which is made possible by the modular configuration and associated licensing structure of the subnets.

In general, a system and a method are provided for generating a list of domains and using the list of domains to control access to web content. It includes providing an open subnet server to receive one or more proposed web pages to be added to a white list on the list of domains, as well to receive one or more votes from one or more users whether or not to add one or more of the web pages to the white list; and providing one or more licences to permit access to the white list.

In another aspect, the one or more users include registered and unregistered users. In another aspect, a registered user has a profile that includes one or more exception web pages that are blocked from the white list, but deemed acceptable to the registered user. In another aspect, a registered user has a profile that includes one or more exception web pages that are approved on the white list, but deemed unacceptable to the registered user. In another aspect, voting for the one or more web pages further comprises calculating a total voting score from the one or more votes from the one or more users. In another aspect, each of the one or more votes has an increment or a decrement value. In another aspect, the one or more users are categorized into user types, and the increment or the decrement value varies by each user type. In another aspect, votes from at least one of the user types has a maximum contribution to the total voting score. In another aspect, the user types comprise one or more guests, one or more members, and one or more owners, with the owners having the highest increment or decrement value and with the guests having the lowest increment or decrement value. In another aspect, the one or more owners have veto power to approve or deny the one or more web pages being added to the white list. In another aspect, based on the total voting score, the one or more proposed web pages can be approved, denied, or pending. In another aspect, it further comprises providing a sync server connected to the open subnet server, the sync server obtaining a copy of the white list and, based on an end user's license to the list of domains, providing to the end user access to web pages on the white list. In another aspect, it further comprises providing a search engine connected to the open subnet server for the end user to search the web pages on the white list.

It is also recognized that controlling access to websites or web pages in work environments can be difficult. For example, certain web pages may be appropriate for work and certain web pages may not be appropriate for work. However, determining which web pages are appropriate and which are not is time consuming. Furthermore, should a single administrator be solely responsible for controlling access to websites, employees may be inadvertently prevented from accessing web pages that may be legitimately related to work. It is also recognized that employees may wish to view web pages not related to work, for example, for recreational or personal reasons. An employer may find it difficult to strike a balance between controlling the access to websites and fostering a relationship of trust with employees. With too little control, employees may spend too much time on recreational web pages, or may visit web pages at inappropriate times, or may visit web pages that are against company policy. With too much control, employees may become disgruntled with the employer since they are being prohibited to view recreational web pages. This may harm the relationship between the employee and the employer. For example, an employee might feel a lack of trust from the. employer. Furthermore, as previously described, too much control may inadvertently restrict employees from accessing web pages that are related to work.

To address such issues, in addition to the above described systems and methods, further systems and methods are provided to allow employees to determine whether a web page is related to work or related to recreation. An administrator, for example an employer, can view or oversee which web pages are categorized as work or recreation, and can adjust the categorization. This allows employees to take ownership over the web pages they visit, while allowing an employer to have some control over the web pages accessed by the employees. This also allows an employer to reinforce their trust in the employees' decisions for categorizing the websites. It can be appreciated that different numbers of categories having different names and meanings are applicable to the principles described herein.

It can be appreciated that the terms “personal”, “recreation” and “recreational” are interchangeably used herein.

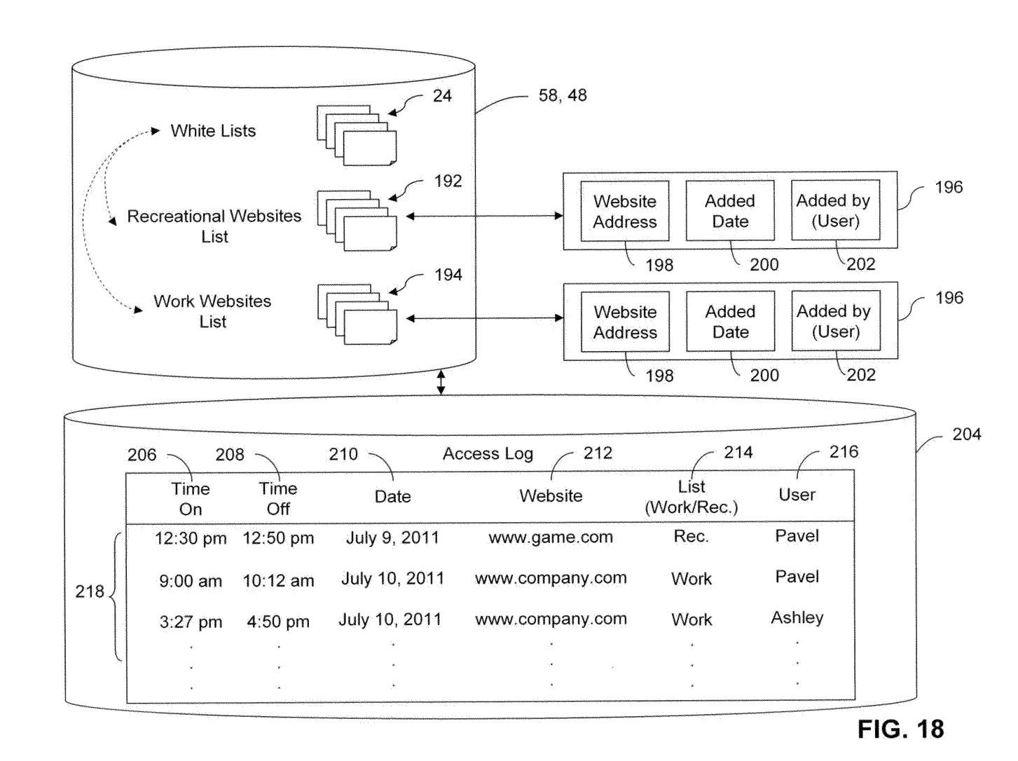

In particular, turning to FIG. 18, the white lists database 58, or copy thereof 48, includes white lists 24, recreational web page lists 192, and work web page lists 194. The recreational web page lists 192 includes one or more web pages that are categorized as being related to recreation or personal use. The work web page lists 194 includes one or more web pages that are categorized as being related to work. A user, for example, an employee, may add a web page to the recreational list 192 or the work list 194. Data 196 related to the websites in the lists 192, 194, 24 may also be recorded. The data 196 may include the web page address 198, the date 200 that the web page was added to the list, and an identity of a user 202 who added the web page to the list.

An access log 204 may also store data related to, for example, when a web page was accessed, who accessed the web page, and a categorization of the web page. Example data recorded includes the time the web page was accessed 206, the time the web page was closed or stopped being viewed 208, the date the web page was accessed 210, the web page address 212, the categorization of the web page (e.g. work or recreation) 214, and an identity of the use who accessed the web page 216. Example entries 218 of the access log 204 are provided in FIG. 18.

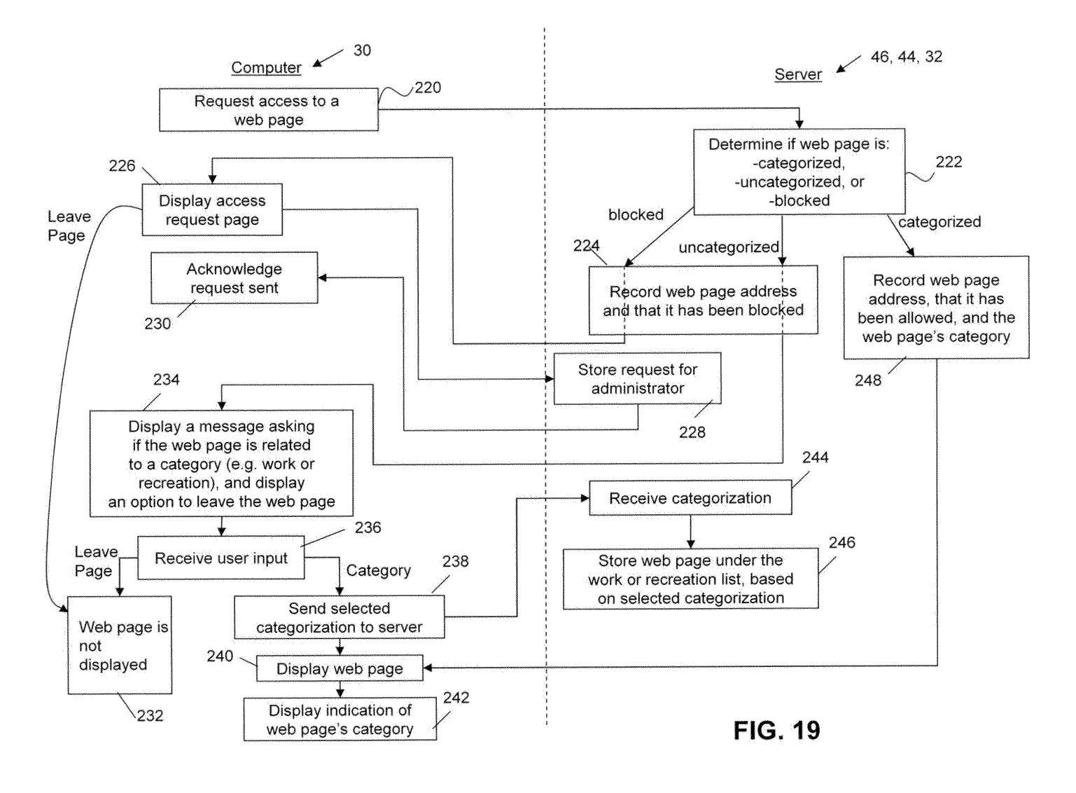

Turning to FIG. 19, example computer executable instructions are provided for accessing a web page. A computer 30 at block 220 requests access to a web page. The request is sent to a server, such as one of the servers 46, 44 or 32. The server then determines at block 222 if the web page is categorized, uncategorized, or blocked, for example, based on rules or known conditions. The categories can include, for example, work and recreation.

If the web page is blocked, then at block 224, the web page address is recorded in memory, as well as the determination that the web page has been blocked. Other information may include the time that the web page was blocked, as well as which user attempted to access the web page. At block 226, the computer 30 displays an access request page. The user can use the access request page to submit a request to access the web page. This request is stored on the server for the administrator's consideration (block 228). The computer 30 then provides an acknowledgement that the request was sent to the server (block 230). It can be appreciated that, from the access request, page, the user may select an option to leave the page. If so, turning to block 232, the web page is not displayed and an exit page may instead be displayed.

If the web page is uncategorized, then at block 224, the web page address is recorded in memory, as well as the determination that the web page has been uncategorized. Other information may include the time at which a request was received to access the web page, as well as which user attempted to access the web page. At block 234, the computer 30 displays a message asking if the web page is related to a category, such as work or recreation, and displays an option for the user to leave the web page. The message can be displayed through a graphical user interface (GUI) that allows a user to provide a categorization of the web page, or to leave the web page.

At block 236, a user input is received. If the user provides an input to leave the page, then the web page is not displayed (block 232). If the user input is a category, at block 238, the computer 30 sends the selected categorization to the server. The computer 30 displays the web page (block 240). At block 242, the computer 30 may, for example, display an . 5 indication of the categorization. For example, if the category is recreation, the computer 30 displays an indication that the web page is categorized as recreation. In another example, if the category is work, the computer 30 displays an indication that the web page is categorized as work.

Continuing with FIG. 19, the server receives the categorization (block 244) and stores the web page under a list corresponding to the categorization. For example, if the categorization is recreation, then the web page address is stored under the recreation list. If the categorization is work, then the web page address is stored under the work list.

If the web page is categorized, for example already listed on any one of a white list, a work list, or a recreational list, then the process continues to block 248. At block 248, the server records the web page address, an indicator that access to the web page is allowed, and the categorization of the web page. The computer 30 displays the allowed web page (block 240), and may display an indication of the web page's categorization (block 242).

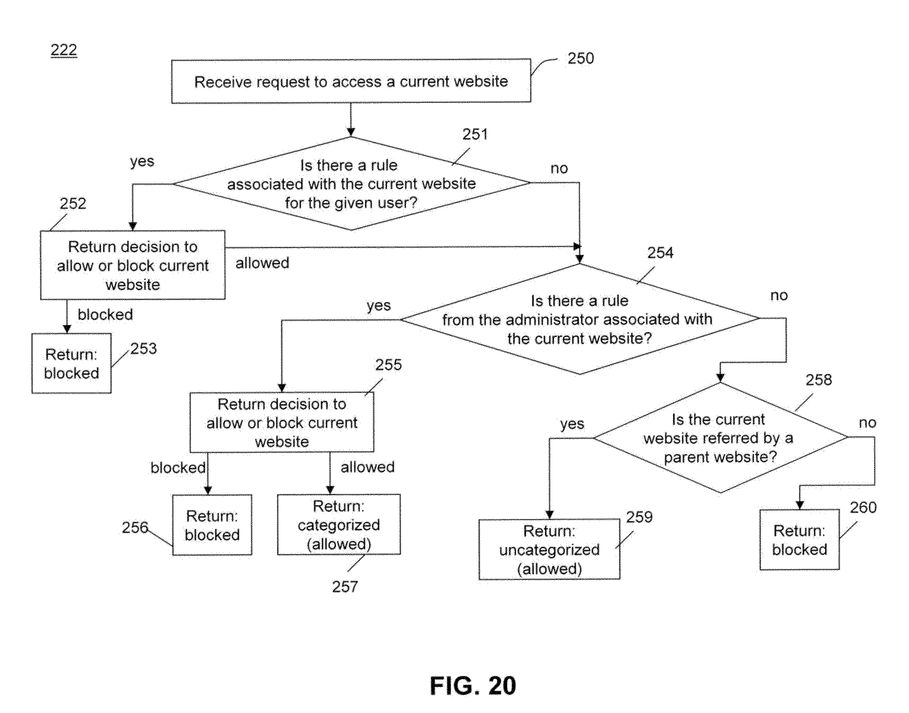

Turning to FIG. 20, example computer executable instructions are provided for determining if a web page is blocked, uncategorized or categorized according to block 222 of FIG. 19. Such computer executable instructions may be performed by the server. Referring to block 250 in FIG. 20, the server receives the request to access a current web page. The server then determines if there is a rule associated with the current web page for the given user requesting the access (block 251). If there is a rule, at block 252, the server applies the rule to return a decision to allow or block the current web page for the current user. If the decision is that the web page is blocked, such a result is returned (block 253). If the decision is that the web page is allowed, then the process continues to block 254.

If; from block 251, it is determined there is no rule associated with the current website for a given user, the process also continues to block 254.

At block 254, it is determined if there is a rule from the administrator associated with the current web page. The rule from the administrator may apply to multiple or all users, including the given user. If there is a rule from the administrator, at block 255, the server returns a decision to allow or block the current web page based on the application of the rule. If blocked, a “blocked” result, for example, is returned (block 256). If the rule allows the web page, it is appreciated that there is a category associated with the web page. Accordingly, at block 257, the server returns an indication that the web page is categorized.

If, from block 254, there is no rule from the administrator, then at block 258, it is determined if the current web page is referred by a parent web page. If not, then an indicator that the web page is blocked is returned (block 260). Otherwise, if the current web page is referred by a parent web page, then an indicator is returned that the current web page is uncategorized (block 259).

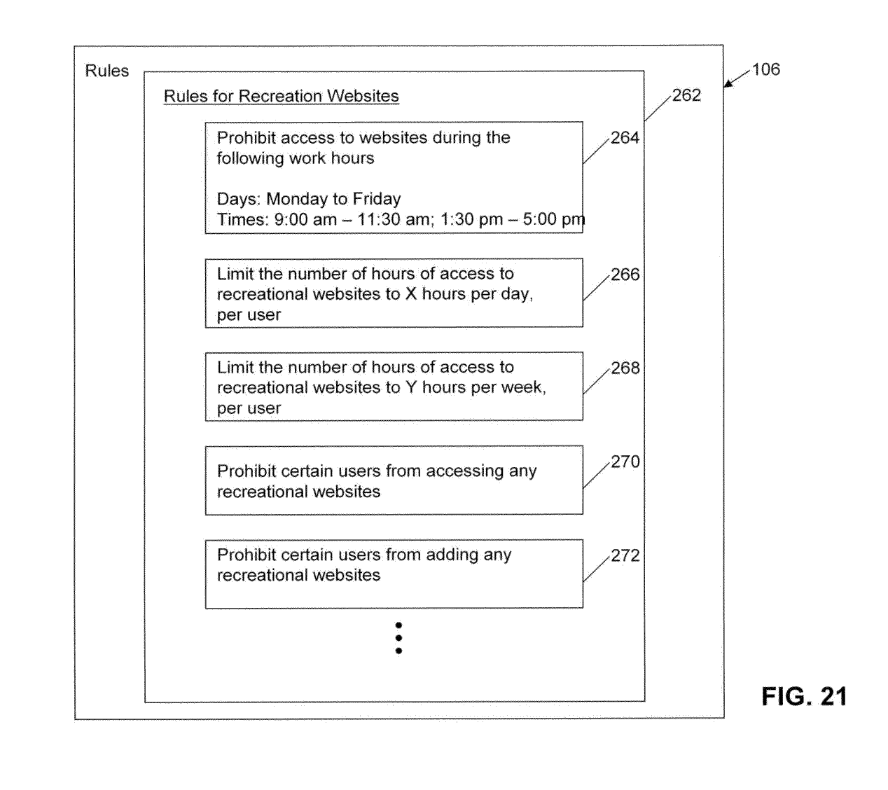

FIG. 21 displays some example rules for recreational websites 262 which may be stored as part of the rules 106. One or more these rules may be applied when executing the operations in FIG. 20. Referring to FIG. 21, rule 264 prohibits access to web pages categorized under recreation during certain time periods, for example, during work hours. Example work hours may be Monday to Friday, between 9:00 am-11:30 am, and between 1:30 pm-5:00 pm. This allows users to view recreational web pages, for example, before or after work hours, or during lunch breaks. Other time periods and dates may also be used.

Rule 266 limits the number of hours of access to recreational web pages to a certain number of hours per day, per user. Similarly, rule 268 limits the number of hours of access to recreational web pages to a certain number of hours per week, per user.

An administrator may prohibit certain users from accessing any recreational web pages (rule 270). This may, for example, be used to reprimand certain users. Additionally, a user may be prevented from adding any recreational web pages to the recreational web pages lists 192.

Similar rules may apply to work web pages lists 194.

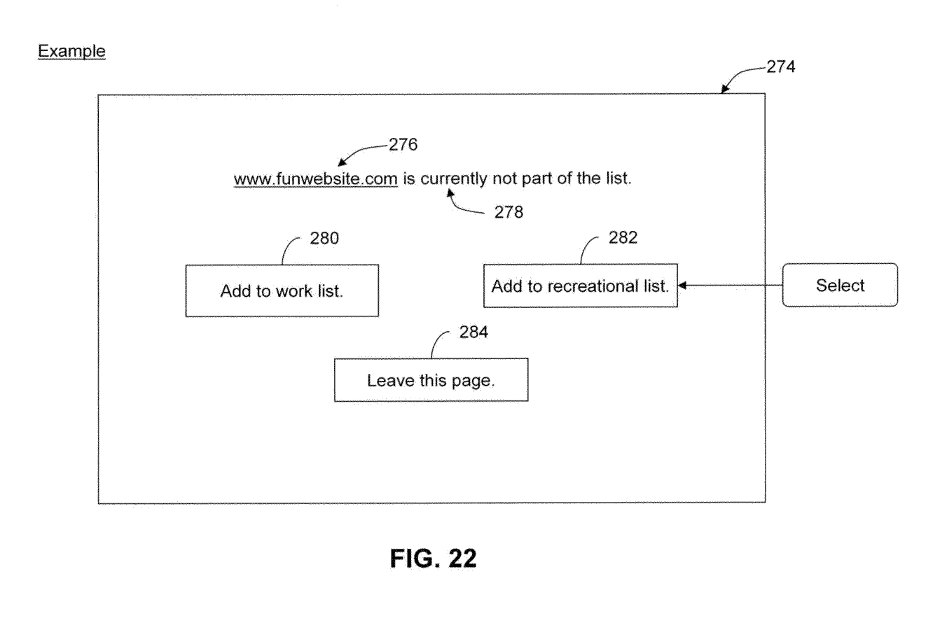

Turning to FIG. 22, an example GUI 274 is provided. The GUI 274 may be shown, for example, when executing block 234 in FIG. 19. The GUI 274 can be shown for example in an Internet browser. Referring to FIG. 22, the GUI 274 displays a message 278 indicating that a certain web page 276 is not on a list, such as a recreational web page list, a work web pages list, or a white list. Option buttons 280 and 282 are provided to allow a user to categorize the web page 276 as being related to work or recreation, respectively. There is also the option 284 to not select a category, and leave the page. If option button 284 is selected, then the webpage 276 is not shown.

If the user selects option button 280, then the web page 276 is categorized as work. If the user selects option button 282, then the web page 276 is categorized as recreational. If, for example, option button 282 or 284 is selected, then the web page is displayed.

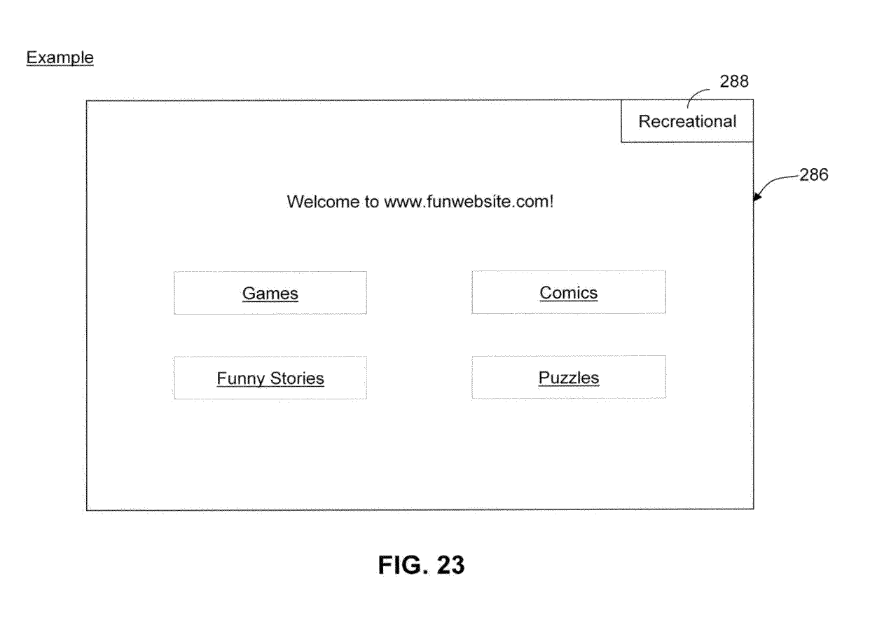

Turning to FIG. 23, an example web page 286 is shown. For example, if option button 282 is selected on the GUI 274, then the web page 286 may be shown. Since the web page 286 is categorized as being recreational, there may be an indicator 288 shown with web page 286 indicating the recreational category. The indicator may include a graphic or text, or both.

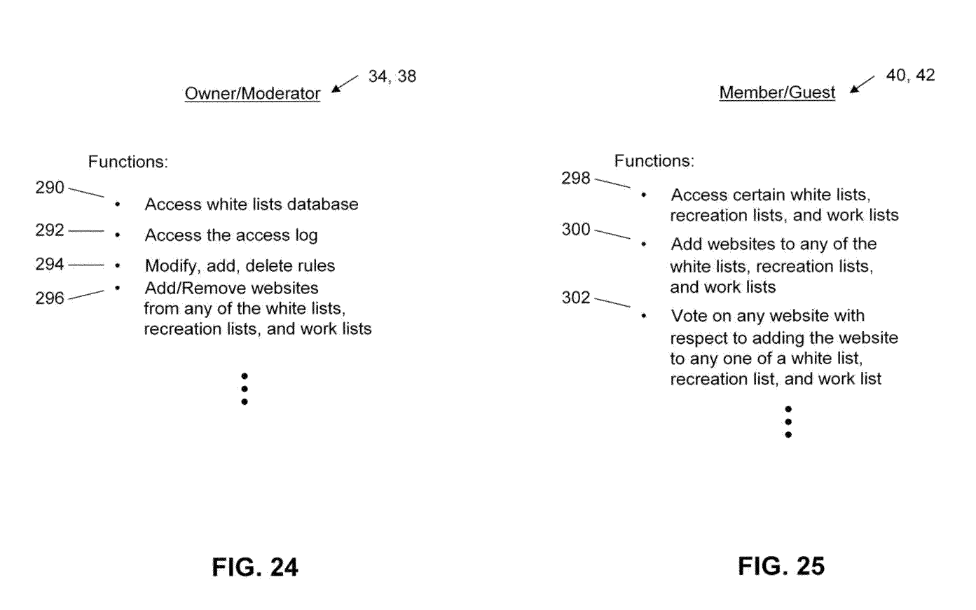

Turning to FIG. 24, a listing of functions of the owner 34 or moderator 38 are provided. The functions include, for example, accessing the white lists database 290 and accessing the access log 292. Another function 294 can include modifying, adding and deleting rules. Another function 296 can include adding or removing web pages from any of the white lists, recreation lists and work lists.

Turning to FIG. 25, a listing of functions of a member 40 or a guest 42 are provided. Function 298 includes accessing certain white lists, recreation lists, and work lists. Function 300 includes adding websites to any of the white lists, recreation lists and work lists. Function 302 includes voting on any web page with respect to adding the web page to any one of a white list, recreation list and work list.

In an example embodiment, the recreation list 192 and the work list 194 can be considered to be a type of white list which can be modified according to a voting process according to the principles described herein. For example, employees may vote whether or not a web page added to the recreation category is indeed part of a recreation list. Similarly, employees may vote on whether or not a web page added to the work category is indeed part of a work list.

In another example embodiment, if an employee visits a web page that has not been categorized, the employee then adds the web page to, for example, the recreation category. When another employee visits the same web page at a later time, the employee does not need to categorize the web page, since it has already been categorized as being related to recreation.

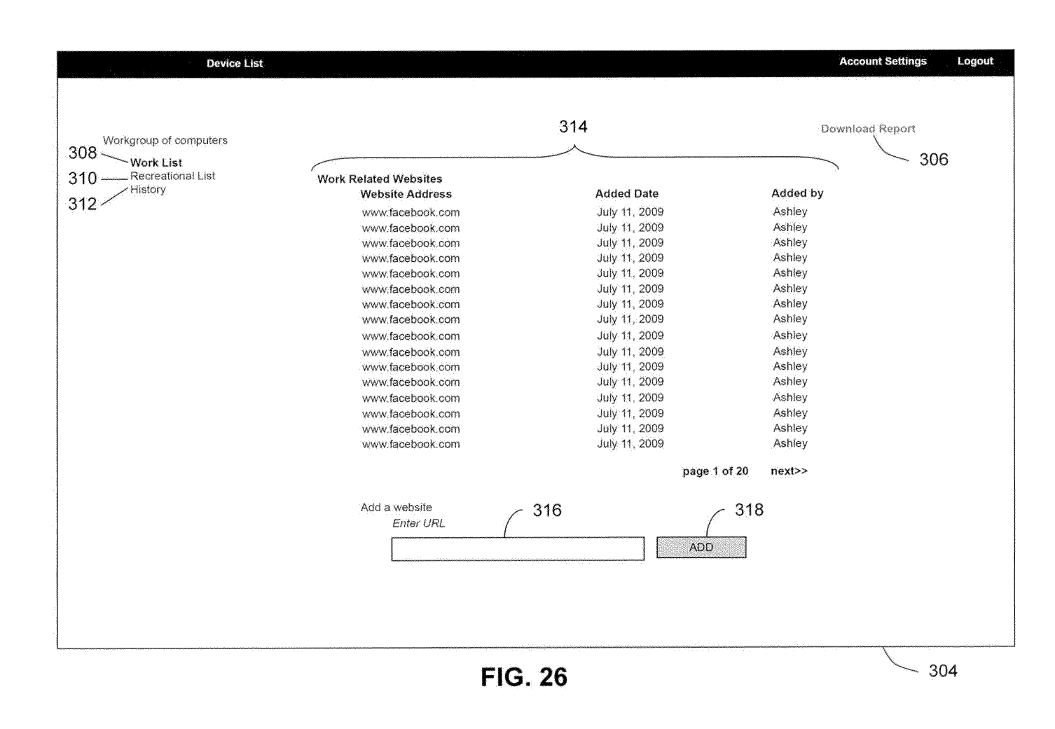

It can be appreciated that data related to the web pages, including their categorization, can be viewed by an administrator. The data can also be downloaded in a report. This allows an administrator to oversee the usage and access to web pages. Examples of GUIs for viewing such data are provided with respect to FIGS. 26, 27, 28a, and 28b.

Turning to FIG. 26, an example GUI 304 shows a listing 314 of web pages added to the work list 194. The listing 314 includes the web page address, the date that the web page was added to the work list, and the identity of the user who added the web page to the work list. The GUI 304 also includes an option 308 to view the work list, an option 310 to view the recreation list, and an option 312 to view the history or access log. A user can select any one of the options 308, 310, 312. In this case, as shown in FIG. 26, the option 308 has been selected, as the listing 314 of web pages categorized under work is displayed.

The GUI 304 also includes an option 306 to download a report. For example, selection option 306 will download a report of the work related web page, the recreation related web pages or the access log.

The GUI 304 also includes a field 316 to enter in a new web page address or URL to be added to the work list. Selecting the button 318 adds the new web page address or URL to the work list.

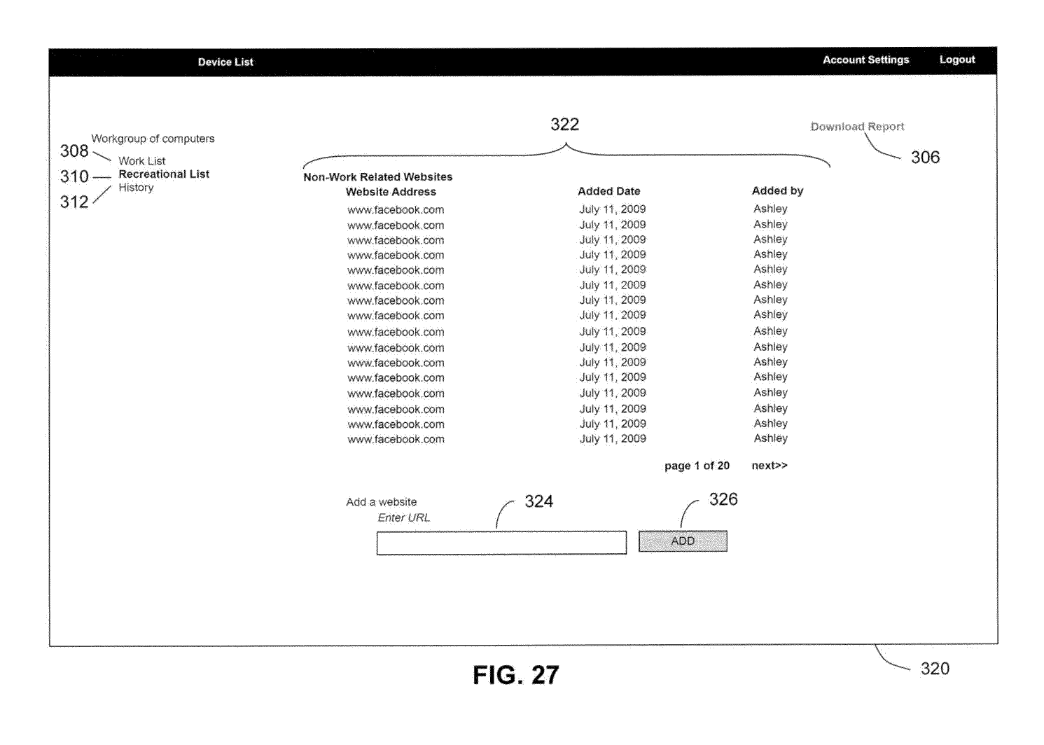

Turning to FIG. 27, an example GUI 320 shows a listing 322 of web pages added to the recreation list. It also includes the web page address, the date that the web page was added to the recreation list, and the identity of the user who added the web page to the recreation list. The GUI 320 also includes a field 324 to enter in a new web page address or URL to be added to the recreation list. Selecting the button 326 adds the new web page address or URL to the recreation list.

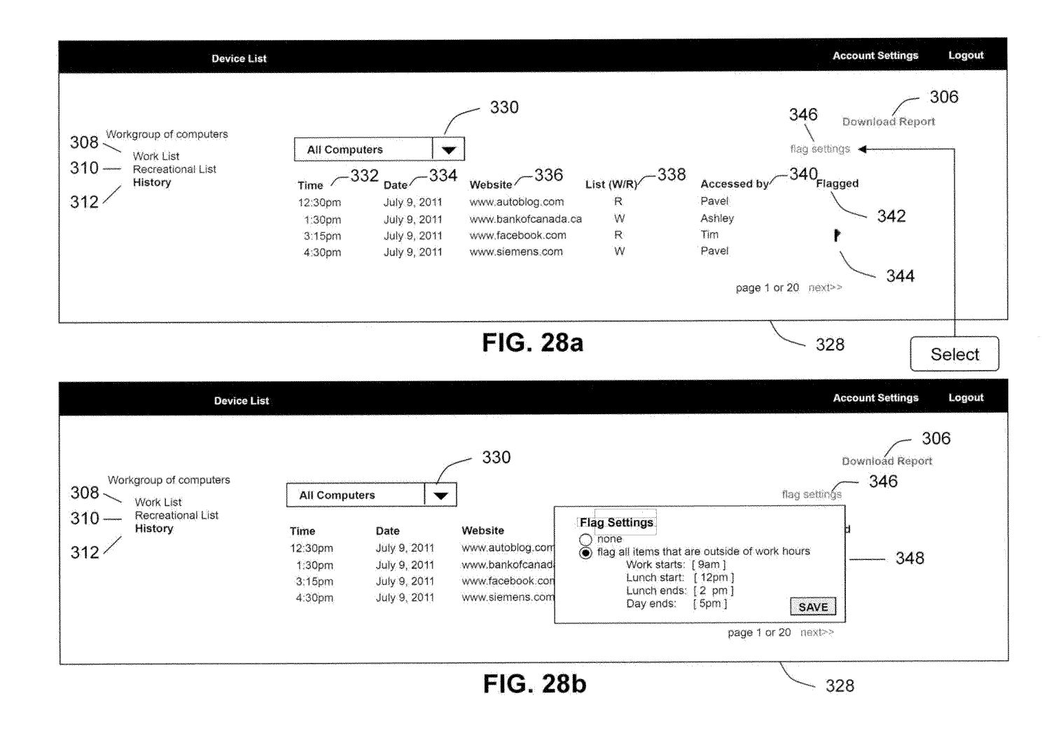

Turning to FIG. 28a, an example GUI 328 is shown displaying the history of web pages accessed by users. The data viewed may be provided from the access log 204. A filter selection 330 allows a user to show certain data entries. For example, a user may wish to view the access log of web pages across all computers. Entry headings for the access log data may include, for example, the time of access 332, the date of access 334, the web page address 336, the category of the web page 338 (e.g. work “W” or recreation “R”), the identity of the user who accessed the web page 340, and an indication of whether the entry in the access log is flagged 342. The indication 344 can, for example, take the form of a flag. A user can select the option 346 to adjust the settings determining which entries are flagged.

For example, by selecting option 346, turning to FIG. 28b, the GUI 348 is displayed. Options are provided to flag all entries in the access log that are outside of work hours. The options include selecting when work starts, when lunch starts, when lunch ends, and when work ends.

In general, the system and method described herein provides access to web pages that are self-regulated, to some extent, by employees. The system allows an employee to provide their claimed “intent” for visiting specific web pages. These web pages are, for example, labelled as “work” or “recreational”. Subsequent visits to a labelled web page will not be interrupted.

In another example aspect, the time of each visit is recorded in the activity log. For example, the exit time (e.g. when the user leaves a web page) is recorded and can be analyzed from the activity log entries. Based on the activity log entries, other factors can be computed, such as for example, the frequency and length of a user's visit on a web page.

In another example aspect, a given web page may be classified by cross-referencing the domain of the web page with public lists. Web pages, for example, that are classified as being related to gambling, gaming and pornography will raise red flags, if the web pages have been labelled by an employee as being related to “work”. In an example embodiment, the classification occurs by incremental tagging. The process of incremental tagging includes, after receiving a request to access a given web page, retrieving a classification of the web page from a public list. The classification of the web page, as well as the web page's domain; is then stored on one of the servers 46, 44, 32. The process is repeated for various web pages of different domains. Web pages of a domain, which has a known classification stored on one of the servers 46, 44, 32, are given the same known classification as the domain.

In another example aspect, the frequency and length of a web page visit and the categorization of the web page or website may be presented in a digested format for the administrator. The administrator may more easily identify from the digested format which web pages cause distractions for each employee, as well as who are the most distracted employees. For example, the web pages may be listed in order from the most frequently visited to the least frequently visited, or from longest duration of visited time to the shortest duration of visited. The most frequently visited web pages, or web pages having the longest duration visits, may be easily identified, as they are at the top of list, as being problematic or distracting to employees. Similarly, employees may be listed in order from those spending the most time on recreational web pages to those spending the least time on recreational web pages. From such an ordered list, an administrator may more easily identify the employees who are most distracted.

In another example aspect, the administrator can prevent access (e.g. either permanently or temporarily) to certain web pages on a per-user basis.

In another example aspect, requests to view a web page are intercepted by a client application on the computer 30, which is then sent to a server (e.g. 46, 44, 32). The server then decides to allow or block access to the web page.

In another example aspect, a non-intrusive block page is displayed, such as for example page 274 in FIG. 22, that allows a user to self-claim their intent (e.g. work or recreation).

In another example aspect, heuristic algorithms are used to estimate the length an employee spends on a web page.

In another example aspect, heuristic algorithms are used for detecting dependent domains. Dependent domains are those that depend from a parent or primary domain. By way of example, a parent domain may be “abc.com” and dependent domains may include “11.channel.abc.com”, “9.channel.abc.com”, “14.channel.abc.com”, etc. The dependent domains provide content that can be displayed or used by the parent domain.

In an example embodiment, by identifying dependent domains with respect to a parent domain, a decision can be made as to whether or not a dependency domain is to be allowed to be accessed based on the parent domain. For example, if the parent domain has been recognized as being categorized as work related, then the dependent domain may also be characterized as being work related.

For example, a user may wish to view a first web page (e.g. www.cnn.com) which is work related. The first website includes a portion of content from a second web page (e.g. www.twitter.com), and the second web page is not approved as a work-related web page. For example, a portion of the content from the second web page is embedded in the first web page. In other words, the second web page is considered the dependent domain, as it depends on the first web page. In an example embodiment, upon detecting there is embedded a portion of content from the second web page in the first web page, the computer or server allows the portion of the content from the second web page to be displayed in the first web page. In another example embodiment, upon detecting there is embedded a portion of content from the second web page in the first web page, the computer or server does not display the portion of the content from the second website in the first website.

It can be appreciated that the dependent domain (e.g. the second website) is detected by checking the domain referrer (e.g. HTTP referrer). It can be appreciated that a domain referrer identifies, from the point of view of an Internet webpage or resource, the address of the web page (commonly the Uniform Resource Locator (URL); the more-generic Uniform Resource Identifier (URI); or the internationalization and localization (i18n)-updated Internationalized Resource Identifier (IRI)) of the resource which links to it. By checking the referrer, the new web page can see where the request originated. The client application on the computer intercepts both requests (e.g. one from the first web page, one from the second web page) and provides the server 46, 44, 32 with such information. Web pages that have heavy traffic such as Facebook or Twitter deploy satellite servers, or server clusters. The system described herein gathers referral data over time from multiple visits, so that the cluster structure will be discovered over time. By discovering which servers or dependent domains are correlated with a given parent server or parent domain, for subsequent visits to the dependent domains that are correlated with the parent server or domain, the server will automatically provide access to such correlated or clustered dependent domains.

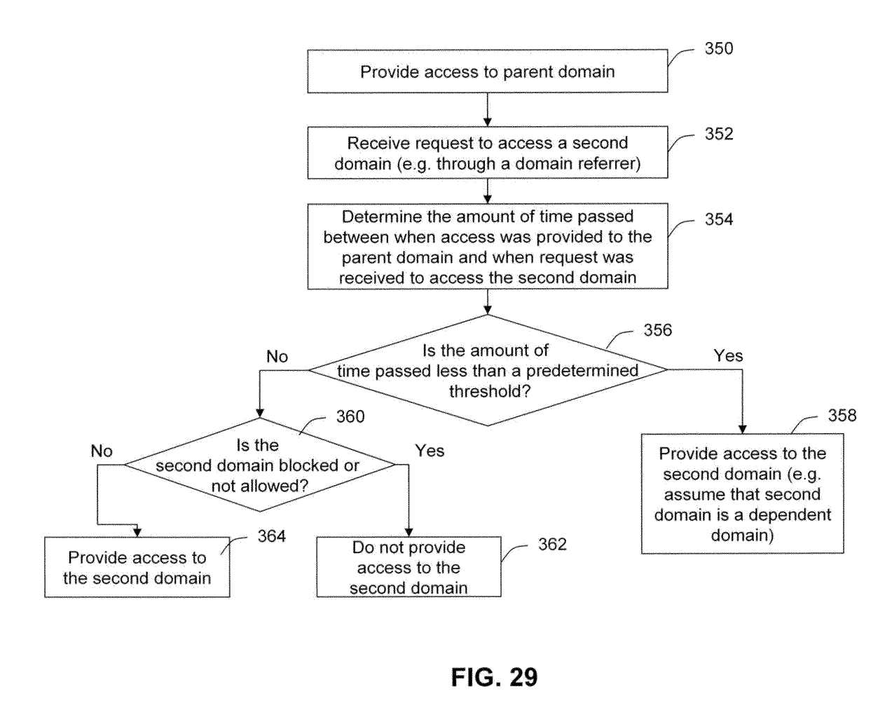

Turning to FIG. 29, another example embodiment is provided for determining whether access should automatically be provided to a dependent domain. If a domain is in fact a dependent domain that depends from a parent domain, there should be domain referrers from the parent domain that automatically request to access content from the dependent domain. However, it is recognized that a user may simply provide a request to access a second web page domain from the parent'web page domain, for example by selecting a link on the parent web page that will access the second web page domain. In such a case, the second web page is herein not considered to be a dependent domain.

Referring to FIG. 29, at block 350, a server (e.g. 46, 44, 32) provides access to the parent domain. At block 352, the server receives a request to access a second domain. The request may be automatically generated, for example from a domain referrer, or may originate from a user requesting to access the second web page, for example by selecting a link. At block 354, the server determines the amount of time passed between when the access was provided to the parent domain and when the request was received to access the second domain. At block 356, it is determined if the amount of time passed is less than a predetermined threshold. In an example embodiment, the predetermined threshold is a short time period (e.g. a second or less) and is used as a filter to determine whether the request to access the second domain was automatically generated or manually generated. It is assumed that automatically generated requests occur almost immediately after accessing the parent domain, while manually generated requests take some time for a user (e.g. to select a link to attempt to access the second web page). From block 356, if the amount of time is less than the threshold, then at block 358, the server provides access to the second domain. For example, the second domain may be considered to be a dependent domain of the parent domain. However, if the amount of time is equal to or more than the threshold, then at block 360, the server determines if the second domain is blocked or not allowed according to some policy or black list. If so, at block 362, access to the second domain is denied. If not, at block 364, access to the second domain is provided. For example, the process for providing access to the second domain may be processed according to the operations in FIGS. 19 and 20 as described above.

It is appreciated that there may be various way to detect when a user has left or exited a web page. In an example embodiment, multiple heuristics are used to estimate the time that a user has exited a web page. These heuristics may include, for example, minimum access time per entry and average page transition intervals.

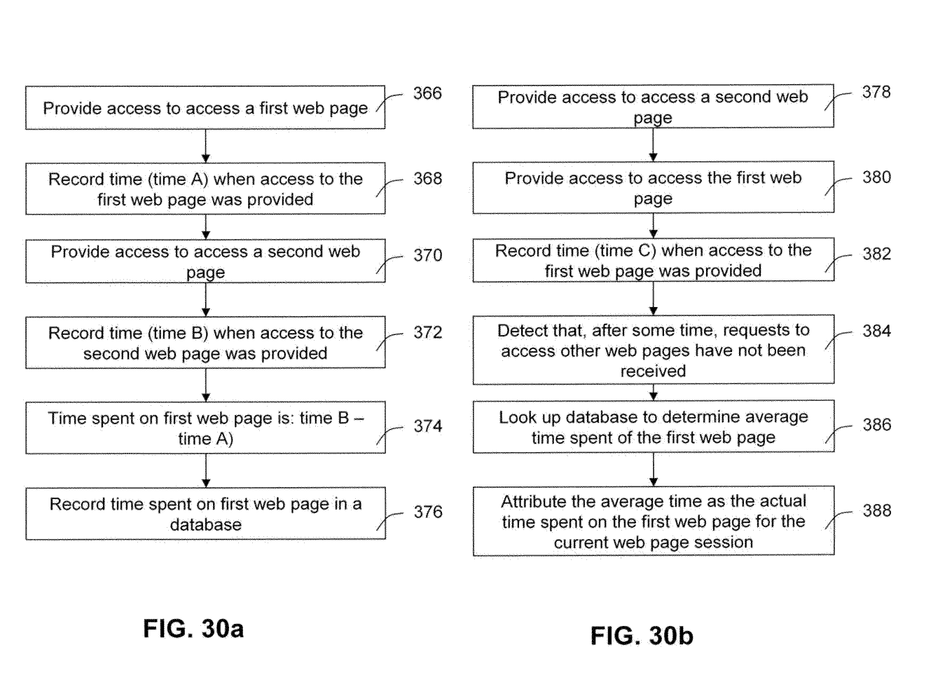

Turning to FIG. 30a and FIG. 30b, example computer executable instructions are respectively provided for collecting data and using the heuristics to estimate when a user has left or exited a web page. Referring to FIG. 30a, at block 366 the server (e.g. 46, 44, 32) provides access to a first web page. At block 368, the server records the time (e.g. time A) when access to the first web page was provided. At block 370, the server provides access for the same user (e.g. the user's computer) to a second web page. At block 372, the server records the time (e.g. time B) when access to the second page was provided. The time the user spent on the first web page is then computed according to the difference between time B and time A (e.g. time spent on web page=time B−time A). At block 376, the time spent on the first web page is recorded in a database. For each visit to the first web page, the time spent on the first web page is recorded in the database. For example, the database may store multiple entries of the amount of time a user has spent accessing the first web page during each visit. It is appreciated that when the first web page is accessed, and then another web page is accessed, it is assumed that the user is no longer viewing the first web page, and thus the user has left or exited the first web page.

However, in some situations, the user views the first web page last, and may not access a further web page. For example, the user may simply leave the computer or shut down the computer while the first web page is being displayed. In such a situation, it is more difficult to determine when the user has left or exited the first web page. For example, referring to FIG. 30b, in another web surfing session, at block 378, the server may provide access to a second web page. The server then provides access to the first web page (block 380). The server records the time (e.g. time C) when access to the first web page was provided (block 382). The server, at block 384, then detects that after some time a request to access another web page has not been received. In other words, it is considered that user may have finished the web surfing session. At block 386, the server accesses the database to determine the average time that the user has spent on the first web page. The average time, for example, can be computed based on the entries recording the amount of time the user has spent accessing the web page on previous visits. At block 388, the average time is then attributed as the actual time the user (e.g. the user's computer) has spent accessing the first web page for the current web surfing session.

In another example embodiment, the time that a user has spent on a web page is based on information provided by another tracking system. For example, when visiting a parent domain, there may be embedded therein information from a dependent domain. The dependent domain may be associated with a tracking system that provides information about when a user has accessed and left a web page, as well as how much time the user has spent on the web page. For example, if the parent domain automatically calls on a dependent domain, and it is assumed that there is a strong affinity between the parent domain and the dependent domain, then the tracking information from the dependent domain is applied to the parent domain. The affinity can be expressed as a value (e.g. an affinity value). For example, if the tracking system of the dependent domain detects that a user is accessing the dependent domain for 30 minutes, and if the affinity value is above a predetermined threshold, then it is established that the user is also accessing the parent domain for 30 minutes.

In an example embodiment of computing the affinity value, an occurrence is considered the dependent domain being accessed as a result of the parent domain. As the number of such occurrences increases, the affinity value between the parent domain and dependent domain also increases.

In another example aspect, the data from the activity log can be presented according to the top visited websites or web pages. For example, web pages that are the most frequently visited, or have the longest duration visits, or both, can be displayed to the administrator. This may help filter out less relevant data.

In an example embodiment, a method for controlling access to a web page is provided. The method comprises: receiving an input to access the web page; determining if the web page is on a work list or a recreation list, the work list comprising one or more web pages related to work and the recreation list comprising one or more web pages related to recreation; if not, requesting a categorization of the web page; and after receiving the categorization, storing the web page in the work list or the recreation list, and providing access to the web page.

In another example aspect, the categorization of the web page is requested by displaying a message on a display screen with an option to categorize the web page as being related to work or as being related to recreation. In another example aspect, if the categorization is work related, then the web page is stored in the work list, and if the categorization is recreation related, then the web page is stored in the recreation list. In another example aspect, if the categorization is not received, then access to the web page is denied. In another example aspect, the method further comprises, after providing access to the web page, the web page is displayed on a display screen and an indicator of the categorization is displayed with the web page. In another example aspect, the indicator of the categorization is indicates that the web page is related to work or to recreation. In another example aspect, an identity of a user who added the web page to either the work list or the recreation list is stored in association with the web page. In another example aspect, the method further comprises monitoring usage of the web site by recording any one of a time the web page was accessed, a time the web page stopped being accessed, and an identity of a user who accessed the web page. In another example aspect, if the web page is on the work list or the recreation list, the method further comprises: determining if one or more rules are applicable to accessing the web page; and if so, applying the one or more rules. In another example aspect, the one or more rules are applicable to the recreation list comprising the one or more web pages related to recreation. In another example aspect, the one or more rules comprises prohibiting access to the one or more web pages related to recreation during a certain time period. In another example aspect, the one or more rules comprises limiting a cumulative period of time, for accessing to the one or more web pages related to recreation, to a threshold. In another example aspect, the one or more rules comprises prohibiting a certain user from accessing the one or more web pages related to recreation. In another example aspect, the method further comprises receiving one or more votes to determine if the web page will remain being stored in the work list or the recreation list. In another example aspect, the method further comprises: after providing access to the web page, receiving another request to access another web page; determining an amount of time passed between when access to the web page was provided and when the other request to access the other web page was received; and if the amount of time is less than a predetermined threshold, providing access to the other web page. In another example aspect, if the amount of time is equal to or greater than the predetermined threshold, then determining whether or not the other web page is blocked from access. In another example aspect, the method further comprises collecting data relating to an amount of time spent accessing the web page for one or more visits to the web page and using the data to estimate an amount of time spent accessing a web page for a subsequent visit to the web page.

In another example embodiment, a method for controlling access to a web page is provided. The method comprises: receiving an input to access the web page; determining if the web page is on at least one list, each of the at least one list comprising one or more web pages related to a respective category; if not, requesting a categorization of the web page; and after receiving the categorization, storing the web page on one of the least one list corresponding to the categorization; and providing access to the web page.

In another aspect, the step of determining if the web page is on at least one list comprises determining if the web page is on a first list or on a second list.

In another example embodiment, a method of accessing a web page is provided. The method is performed by a computer, and the method comprises: receiving a request to access the web page; displaying a graphical user interface (GUI) to provide a categorization of the web page; receiving the categorization of the web page; sending the categorization of the web page to a server; and, displaying the web page.

It can be appreciated that the above examples were provided with respect to work and recreation categories. The principles described herein may also apply to different categories of any number. For example, one category may be engineering, another category may be finance, and another category may be human resources.

Although the above principles have been described with reference to certain specific embodiments, various modifications thereof will be apparent to those skilled in the art without departing from the scope of the claims appended hereto.

1. A method for controlling access to a web page, the method comprising:
receiving an input to access the web page;
determining if the web page is on a work list or a recreation list, the work list comprising one or more web pages related to work and the recreation list comprising one or more web pages related to recreation;
if not, requesting a categorization of the web page; and
after receiving the categorization, storing the web page in the work list or the recreation list, and providing access to the web page.

2. The method of claim 1 wherein the categorization of the web page is requested by displaying a message on a display screen with an option to categorize the web page as being related to work or as being related to recreation.

3. The method of claim 1 wherein if the categorization is work related, then the web page is stored in the work list, and if the categorization is recreation related, then the web page is stored in the recreation list.

4. The method of claim 1 wherein if the categorization is not received, then access to the web page is denied.

5. The method of claim 1 further comprising, after providing access to the web page, the web page is displayed on a display screen and an indicator of the categorization is displayed with the web page.

6. The method of claim 5 wherein the indicator of the categorization is indicates that the web page is related to work or to recreation.

7. The method of claim 1 wherein an identity of a user who added the web page to either the work list or the recreation list is stored in association with the web page.

8. The method of claim 1 further comprising monitoring usage of the web site by recording any one of a time the web page was accessed, a time the web page stopped being accessed, and an identity of a user who accessed the web page.

9. The method of claim 1 wherein if the web page is on the work list or the recreation list, the method further comprising:
determining if one or more rules are applicable to accessing the web page; and
if so, applying the one or more rules.

10. The method of claim 9 wherein the one or more rules are applicable to the recreation list comprising the one or more web pages related to recreation.

11. The method of claim 10 wherein the one or more rules comprises prohibiting access to the one or more web pages related to recreation during a certain time period.

12. The method of claim 10 wherein the one or more rules comprises limiting a cumulative period of time, for accessing to the one or more web pages related to recreation, to a threshold.

13. The method of claim 10 wherein the one or more rules comprises prohibiting a certain user from accessing the one or more web pages related to recreation.

14. The method of claim 1 further comprising receiving one or more votes to determine if the web page will remain being stored in the work list or the recreation list.

15. The method of claim 1 further comprising:
after providing access to the web page, receiving another request to access another web page;
determining an amount of time passed between when access to the web page was provided and when the other request to access the other web page was received; and
if the amount of time is less than a predetermined threshold, providing access to the other web page.

16. The method of claim 15 further comprising, if the amount of time is equal to or greater than the predetermined threshold, then determining whether or not the other web page is blocked from access.

17. The method of claim 1 further comprising collecting data relating to an amount of time spent accessing the web page for one or more visits to the web page and using the data to estimate an amount of time spent accessing a web page for a subsequent visit to the web page.

18. A method for controlling access to a web page, the method comprising:
receiving an input to access the web page;
determining if the web page is on at least one list, each of the at least one list comprising one or more web pages related to-a respective category;
if not, requesting a categorization of the web page; and
after receiving the categorization, storing the web page on one of the least one list corresponding to the categorization; and
providing access to the web page.

19. The method of claim 18 wherein the step of determining if the web page is on at least one list comprises determining if the web page is on a first list or on a second list.

20. A method of accessing a web page, the method performed by a computer, the method comprising:
receiving a request to access the web page;
displaying a graphical user interface (GUI) to provide a categorization of the web page;
receiving the categorization of the web page;
sending the categorization of the web page to a server; and,
displaying the web page.
